(19) United States
(12) Patent Application Publication
(10) Pub. No.: US 2011/0222789 A1
(43) Pub. Date: Sep. 15, 2011

(54) CHARACTER STRING SENSING DEVICE, CHARACTER EVALUATING DEVICE, IMAGE PROCESSING DEVICE, CHARACTER STRING SENSING METHOD, CHARACTER EVALUATION METHOD, CONTROL PROGRAM, AND RECORDING MEDIUM

(75) Inventor: Tomoyoshi Aizawa, Kyoto-shi (JP)

(73) Assignee: OMRON CORPORATION, Kyoto-shi (JP)

(21) Appl. No.: 13/034,379

(22) Filed: Feb. 24, 2011

(30) Foreign Application Priority Data
Mar. 15, 2010 (JP) 2010-058550

(51) Int. Cl. G06K 9/72

(52) U.S. Cl. 382/229

(57) ABSTRACT

Reduction of a processing load, and shortening of a processing time, is realized by performing character string sensing processing on an image. A character string sensing device senses a character string including at least one character from an image. The character string sensing device includes a character information storage unit in which an evaluation value, expressing difficulty of false sensing of the character, is stored in each character. The character string sensing device also includes a search sequence determining unit that determines a search sequence of each character based on the evaluation value of each character included in a keyword input to the character string sensing device as the character string to be sensed. The evaluation value is stored in the character information storage unit. A character search unit searches each character included in the keyword according to the determined search sequence.

### BACKGROUND OF THE INVENTION

1. Technical Field

One or more embodiments of the present invention relates to a character sensing processing that senses a character from an image by processing data of the image such as a still image and a moving image.

2. Related Art

There are many technologies for sensing a specific character (keyword) in an image (still image or moving image). For example, in a technology disclosed in Japanese Unexamined Patent Publication Nos. 08-205043, 2006-134156, and 2008-131413, all character regions in an image are cut out, character recognition processing is performed to each cut-out character region, and the character region is converted into text data to determine whether the text data is a keyword to be sensed.

However, there is the following issue in the technology disclosed in Japanese Unexamined Patent Publication Nos. 08-205043, 2006-134156, and 2008-131413. That is, in order to determine whether the text data is a keyword to be sensed, it is necessary to perform the recognition processing to all the characters cut out from the image, which results in a lengthening of processing time.

For example, when the recognition target character is Japanese or Chinese, there are a huge number of characters (at least 3000 characters only in JIS level-1 kanji set, and at least 6000 characters in JIS level-1 kanji set and JIS level-2 kanji set). In order to perform the character recognition processing in Japanese or Chinese, it is necessary to perform matching processing with respect to at least 3000 to 6000 characters. As a result, the character recognition processing becomes time-consuming, high-load processing. It is also necessary to perform the matching processing of the keyword to all the recognized character strings, and therefore the processing time is further lengthened.

The issue of the lengthened processing time becomes further compounded in the moving image processing in which real-time processing is required rather than a still image.

On the other hand, Japanese Unexamined Patent Publication Nos. 10-191190 and 2008-004116 disclose a technology of performing matching of images in a character region to sense a target character string. Specifically, a character font constituting a specific keyword is read one by one to draw the character, and a character string image corresponding to the keyword is produced. Then the similar image search is performed to the image with the character string image as a key, thereby sensing the keyword from the image.

According to the technology disclosed in Japanese Unexamined Patent Publication Nos. 10-191190 and 2008-004116, because the character string sensing is performed by the matching processing of the images, it is not necessary to perform the character recognition processing to all the character regions in the image. Therefore, the processing time can be shortened compared with the technology disclosed in Japanese Unexamined Patent Publication Nos. 08-205043, 2006-134156, and 2008-131413.

A corner detecting technology or an outline detecting technology can be used as a technology of detecting a feature quantity of the character from the image in order to perform the matching processing of the images (for example, see Masatoshi Okutomi, et al., “Digital Image Processing”, CG-ARTS Society Press, Mar. 1, 2007 (2nd edition), P. 208 to 210, Section 12-2 “Feature Point Detection”).

However, there is the following issue in the technology disclosed in Japanese Unexamined Patent Publication Nos. 10-191190 and 2008-004116. That is, there is the issue of a memory capacity in which the image of the character string used in the matching processing is stored.

For example, in English, there are plural notation patterns such as “desk”, “Desk”, and “DESK” as the character string that should be searched from the image with respect to the character string of “desk” designated as the keyword. In Japanese, there are notation patterns including not only “ [symbol] ” but also “ [symbol] ” with respect to the character string of “ [symbol] ”. In kanji character, there are two notation patterns of “ [symbol] ” and “ [symbol] ” with respect to the character string of “ [symbol] ”.

In the technology disclosed in Japanese Unexamined Patent Publication Nos. 10-191190 and 2008-004116, because the keyword having one semantic content has the plural notation patterns, it is necessary to produce plural character string images corresponding to the plural notation patterns, which results in an image producing processing load being increased. The images used in the matching are prepared as many as the plural notation patterns and stored, which results in a huge memory capacity being required.

In languages such as Japanese, Chinese, and Korean, there are both horizontal writing and vertical writing as a character spelling direction. Because the horizontal writing and the vertical writing are recognized as different character string images even in the same character string, it is necessary to prepare the images both the horizontal writing image and the vertical writing image in the technology disclosed in Japanese Unexamined Patent Publication Nos. 10-191190 and 2008-004116. Accordingly, the issues of the increased processing load and the memory capacity become further significant. When the number of images to which the matching should be performed is increased, the processing time necessary for the similar image search also becomes troublesome. As described above, the issue of the processing time becomes further significant in the moving image processing in which the real-time processing is required rather than the still image.

The above-described issues are not generated only in the character of the specific languages, but the issues are commonly generated in the character sensing processing of any language. Additionally, the issues also generated not only in the moving image but also in sensing the character from the image including the still image.

### SUMMARY OF INVENTION

One or more embodiments of the present invention implement a character string sensing device that realizes the reduction of the processing load and the shortening of the processing time in performing the character string sensing processing to the image, a character evaluating device, an image processing device, a character string sensing method, a character evaluation method, a control program, and a recording medium. One or more embodiments of the present invention may achieve a balance between memory saving and the reduction of the processing load and the shortening of the processing time in the character string sensing device that performs the character string sensing processing.

In accordance with one aspect of one or more embodiments of the present invention, there is provided a character string sensing device that senses a character string including at least one character from an image includes: a character information storage unit in which an evaluation value expressing difficulty of false sensing of the character is stored by each character; a search sequence determining device for determining a search sequence of each character to search the character from the image based on the evaluation value of each character included in a sensing target character string input to the character string sensing device, the evaluation value being stored in the character information storage unit; and a character search device for searching the image in each character included in the sensing target character string according to the search sequence determined by the search sequence determining device.

According to the configuration, when the character string to be sensed is designated to the character string sensing device, the search sequence determining device refers to the evaluation value in each character of the designated character string from the character information storage unit. The evaluation value indicates the difficulty of false sensing. The search sequence is determined in each character of the designated character string based on the evaluation value.

The character search device performs the search in each character in the determined search sequence.

Therefore, when the character search is performed through the character matching processing without performing the character recognition processing, even if the designated character string includes the plural characters, the characters can be searched one by one to finally sense the designated character string. In the one-by-one searching configuration, the processing load can be reduced compared with the case where the plural characters are searched. It is not necessary to consider the vertical writing and the horizontal writing. As a result, the reduction of the character string sensing processing load and the shortening of the processing time can be realized. Additionally, it is not necessary to previously retain information on characters of the comparison target character string while the vertical writing and the horizontal writing of the comparison target character string are separated, so that the memory saving can be realized in the character string sensing device.

The character string sensing device of one or more embodiments of the invention has the one-by-one searching configuration, and the search sequence determining device determines the sequence of the searched character based on the evaluation value. That is, the search sequence is determined according to the difficulty of false sensing (ease of sensing).

According to the configuration, the character search device can search each character of the designated character string in consideration of the ease of correct sensing and the difficulty of false sensing (ease of sensing). Accordingly, the false sensing can be avoided as much as possible to perform more efficiently the character string sensing processing, and therefore the reduction of the processing load and the shortening of the processing time can be realized.

In the above one aspect, the search sequence determining device determines that a character having the largest evaluation value expressing the difficulty of false sensing is initially searched in the characters included in the sensing target character string.

According to the configuration, the character having the highest possibility of being correctly sensed is preferentially searched irrespective of an original character sequence of the character string, so that the target character string included in the image can efficiently be sensed. When the target character string is not included in the image, the correct decision that the target character string is not included in the image can be made at earlier stage of the character string sensing processing.

In the above one aspect, the search sequence determining device determines the character having the larger evaluation value as a next searched character in the characters on both sides of an already-sensed character in a character alignment of the sensing target character string, when the character search device senses a target character included in the sensing target character string from the image.

It is believed that characters adjacent to the already-sensed character in the character sequence are disposed near the already-sensed character in the image. Therefore, by preferentially searching the characters based on the position of the already-sensed character in the image, the presence or absence of the target character string can be sensed more correctly at an early stage. The accuracy is further improved because the character having the larger evaluation value (that is, hardly-falsely-sensed character) in the adjacent characters is preferentially searched.

In the above one aspect, the search sequence determining device determines the search sequence such that the characters are searched in the descending order of the evaluation value.

According to the configuration, the characters can be sensed in the order from the correctly and easily sensed character irrespective of the original character sequence of the designated character string. Therefore, the target character string included in the image can efficiently be sensed. When the target character string is not included in the image, the decision that the target character string is not included in the image can be made more correctly at an early stage of the character string sensing processing.

In the above one aspect, the character search device narrows a search target region where the next character is searched to a neighboring region of the already-sensed character from a whole region of the image after sensing the target character included in the sensing target character string from the image.

According to the configuration, the character search device searches the character by restricting the search target region from the whole region of the image to the neighboring region of the already-sensed character. Because frequently the character string is vertically or horizontally disposed, when the target character string is sensed, another character is probably disposed in the neighborhood of the target character string.

Thus, the subsequent characters are searched while the region is narrowed to the probably-sensed region. Therefore, the range where the matching processing is performed can largely be reduced to realize the reduction of the processing load and the shortening of the processing time in the character string sensing processing.

In the above one aspect, the character search device restricts the search target region to neighboring regions on the right side of and below the already-sensed character, when the already-sensed character is an nth character in the character alignment of the sensing target character string while the next searched character is a character subsequent to an nth character, and the character search device restricts the search target region to neighboring regions on the left side of and above the already-sensed character, when the next searching character is a preceding character of the nth character.

According to the configuration, the position of the next-searched character can be narrowed more exactly from the position of the already-sensed character based on the original character sequence. That is, in the designated character string sequence, when the next-searched character is the character subsequent to the already-sensed character, probably the next-searched character is disposed on the right of the already-sensed character in the horizontal writing or below the already-sensed character in the vertical writing. When the next-searched character is the preceding character of the already-sensed character, probably the next-searched character is disposed on the left of the already-sensed character in the horizontal writing or above the already-sensed character in the vertical writing.

Thus, the subsequent characters are searched while the region is narrowed to the probably-sensed region. Therefore, the range where the matching processing is performed can largely be reduced to realize the reduction of the processing load and the shortening of the processing time in the character string sensing processing.

In the above one aspect, the evaluation value is computed based on a shape characteristic of the character, in which a character having a more complicated shape is evaluated as having a higher difficulty of false sensing. The evaluation value is computed based on at least one of a characteristic value of an element length expressing a length of a line constituting the character and a characteristic value of a different orientation property expressing versatility of an orientation of the line constituting the character. Further, the characteristic value of the element length and the characteristic value of the different orientation property are computed by adding a weight to an obliquely-oriented line constituting the character rather than a vertically- or horizontally-oriented line constituting the character.

In the above one aspect, the evaluation value is computed based on the characteristic value of ease of discrimination expressing a degree in which the character is easily discriminated from another character, in which a character having a shape less similar to another character or a part of another character is evaluated as having a higher difficulty of false sensing.

In the above one aspect, the evaluation value is computed based on a characteristic value of notation uniformity which is specified based on presence or absence of different notation or a degree of similarity between different notation characters when the different notation is present, in which a character having more uniform notation is evaluated as having a higher difficulty of false sensing.

In the above one aspect, the image is a moving image including a plurality of frames, the character search device searches each character included in the sensing target character string in each search target frame that is extracted as a search target from the moving image, and the character search device ends the search in the search target frame when the character search device does not detect a target character from the search target frame in searching each character according to the search sequence, and searches the character having the first search sequence in the next search target frame.

According to the configuration, the character search device searches the target characters in the order from the hardly-falsely-sensed character according to the determined search sequence with respect to one frame of the moving image. When the target character is not sensed, the search is ended with respect to the frame, and the search is repeated in the order from the hardly-falsely-sensed character with respect to the next frame.

When the characters are searched according to the determined search sequence, the target character string included in the image can efficiently be sensed. When the target character is not included in the image, the decision that the target character string is not included in the image can be made more correctly at an early stage of the character string sensing processing. Therefore, the trouble such that the time is spent to discriminate the confusing, hardly-sensed character, or the trouble such that a loss of the previous character sensing processing is increased because the absence of the character string is found at a final stage can be avoided.

Therefore, the reduction of the processing load and the shortening of the processing time can be realized for the processing load and the processing time, which are the quite significant issues when the moving image, in which the real-time processing is required, is processed to sense the character string.

In accordance with another aspect of one or more embodiments of the present invention, there is provided a character evaluating apparatus includes: a character analysis device for analyzing a character characteristic of an evaluation target character input as a character whose difficulty of false sensing should be evaluated; a character characteristic storage unit in which the character characteristic of each character is previously stored; a characteristic value specifying device for specifying a characteristic value of each character characteristic of the evaluation target character based on at least one of the character characteristic analyzed by the character analysis device and the character characteristic stored in the character characteristic storage unit; an evaluation value computing device for computing an evaluation value expressing difficulty of false sensing of the character using at least one characteristic value specified by the characteristic value specifying device; and an evaluation value storage device for storing the evaluation value computed by the evaluation value computing device in a character information storage unit while correlating the evaluation value with the evaluation target character.

In the above another aspect, the character analysis device analyzes a shape characteristic of the evaluation target character, and the characteristic value specifying device computes at least one of a characteristic value of an element length expressing a length of a line constituting the character and a characteristic value of a different orientation property expressing versatility of an orientation of the line constituting the character with respect to the evaluation target character based on analysis result of the character analysis device.

In the above another aspect, the character characteristic storage unit stores the characteristic value of ease of discrimination expressing a degree in which the character is easily discriminated from another character as a character characteristic by each character, in which a character having a shape less similar to another character or a part of another character is evaluated as having a higher difficulty of false sensing, and the characteristic value specifying device specifies the characteristic value of the ease of discrimination of the evaluation target character based on the character characteristic of the evaluation target character stored in the character characteristic storage unit.

In the above another aspect, the character characteristic storage unit correlates a group of different notation characters and a degree of similarity between different notation characters and stores them as a character characteristic, and the characteristic value specifying device specifies a characteristic value of notation uniformity of the evaluation target character based on presence or absence of different notation of the evaluation target character or a degree of similarity between different notation characters when the different notation is present, in which a character having more uniform notation is evaluated as having a higher difficulty of false sensing.

According to the configuration of the character evaluating device, the difficulty of false sensing of the character can be evaluated based on the specification of the character shape and the linguistic characteristic. When the character string sensing device can previously understand which character is hardly falsely sensed and which character is easily falsely sensed can be previously understood, the character string sensing device can sense the target character string more efficiently from the image in a short time and through low-load processing.

The character string sensing device of one or more embodiments of the invention can be applied to any image processing device that can process the image, and such image processing devices on which the character string sensing device of one or more embodiments of the invention is mounted are also included in the scope of one or more embodiments of the invention.

In accordance with still another aspect of one or more embodiments of the present invention, there is provided a character string sensing method for sensing a character string including at least one character from an image includes the steps of: obtaining a sensing target character string that is input as the character string to be sensed; determining a search sequence of each character for searching the character from the image based on an evaluation value of each character included in the sensing target character string obtained in the character string obtaining step, in which the evaluation value of each character is stored in a character information storage unit, and the evaluation value expresses difficulty of false sensing of the character; and searching the image by each character included in the sensing target character string according to the search sequence determined in the search sequence determining step.

In accordance with still another aspect of one or more embodiments of the present invention, there is provided a character evaluating method includes the steps of: analyzing character characteristic of an evaluation target character that is input as a character whose difficulty of false sensing should be evaluated; specifying a characteristic value of each character characteristic of the evaluation target character based on at least one of the character characteristic analyzed in the character analyzing step and a character characteristic stored in a character characteristic storage unit, in which the character characteristic of each character is previously stored in the character characteristic storage unit; computing evaluation value expressing difficulty of false sensing of the character using at least one characteristic value specified in the characteristic value specifying step; and storing the evaluation value computed in the evaluation value computing step in a character information storage unit while the evaluation value is correlated with the evaluation target character.

The character string sensing device or the character evaluating device may be implemented by a computer. In such cases, a control program for the character string sensing device or character evaluating device, which causes the computer to act as each of the above-described device to implement the character string sensing device or the character evaluating device, and a computer-readable recording medium in which the control program is recorded are also included in one or more embodiments of the invention.

One or more embodiments of the present invention provides a character string sensing apparatus that senses a character string including at least one character from an image, which includes: a character information storage unit in which an evaluation value expressing difficulty of false sensing of the character is stored by each character; a search sequence determining device for determining a search sequence of each character to search the character from the image based on the evaluation value of each character included in a sensing target character string input to the character string sensing device, the evaluation value being stored in the character information storage unit; and a character search device for searching the image in each character included in the sensing target character string according to the search sequence determined by the search sequence determining device.

One or more embodiments of the present invention provides a character evaluating apparatus including: a character analysis device for analyzing a character characteristic of an evaluation target character input as a character whose difficulty of false sensing should be evaluated; a character characteristic storage unit in which the character characteristic of each character is previously stored; a characteristic value specifying device for specifying a characteristic value of each character characteristic of the evaluation target character based on at least one of the character characteristic analyzed by the character analysis device and the character characteristic stored in the character characteristic storage unit; an evaluation value computing device for computing an evaluation value expressing difficulty of false sensing of the character using at least one characteristic value specified by the characteristic value specifying device; and an evaluation value storage device for storing the evaluation value computed by the evaluation value computing device in a character information storage unit while correlating the evaluation value with the evaluation target character.

One or more embodiments of the present invention provides a character string sensing method for sensing a character string including at least one character from an image, which includes the steps of: obtaining a sensing target character string that is input as the character string to be sensed; determining a search sequence of each character for searching the character from the image based on an evaluation value of each character included in the sensing target character string obtained in the character string obtaining step, in which the evaluation value of each character is stored in a character information storage unit, and the evaluation value expresses difficulty of false sensing of the character; and searching the image by each character included in the sensing target character string according to the search sequence determined in the search sequence determining step.

One or more embodiments of the present invention provides a character evaluating method including the steps of: analyzing character characteristic of an evaluation target character that is input as a character whose difficulty of false sensing should be evaluated; specifying a characteristic value of each character characteristic of the evaluation target character based on at least one of the character characteristic analyzed in the character analyzing step and a character characteristic stored in a character characteristic storage unit, in which the character characteristic of each character is previously stored in the character characteristic storage unit; computing evaluation value expressing difficulty of false sensing of the character using at least one characteristic value specified in the characteristic value specifying step; and storing the evaluation value computed in the evaluation value computing step in a character information storage unit while the evaluation value is correlated with the evaluation target character.

Therefore, advantageously the reduction of the processing load and the shortening of the processing time can be realized in performing the character string sensing processing to the image.

### BRIEF DESCRIPTION OF THE DRAWINGS

FIG. 1 is a block diagram illustrating a configuration of a main part of a DVD player according to an embodiment of the invention;

FIG. 2 is a view illustrating examples of character element detecting processing and character element decomposing processing, which are performed by a character analysis unit of a character evaluating device;

FIG. 3A and FIG. 3B are views illustrating specific examples of characteristic values on a shape, which is determined by the character analysis unit;

FIG. 4 is a view illustrating an example of result in which the character analysis unit performs character analysis to plural characters;

FIG. 5A is a view illustrating a specific example of character characteristic information on ease of discrimination, which is stored in a character characteristic storage unit;

FIG. 5B is a view illustrating a specific example of character characteristic information on notation uniformity, which is stored in the character characteristic storage unit;

FIG. 6 is a view illustrating an example of an evaluation value computed by an evaluation value computing unit of the character evaluating device;

FIG. 7 is a view illustrating a specific example of a character database stored in a character information storage unit of a character string sensing device;

FIG. 8 is a flowchart illustrating a flow of character evaluation processing performed by the character evaluating device;

FIG. 9 is a view explaining appearances of an image processing device (DVD player), a display unit (television set), and a manipulation unit (remote controller) of an embodiment and a state in which a user inputs a target character string;

FIG. 10 is a view illustrating an example of a data structure of a keyword retained in a keyword retaining unit of the character sensing device;

FIG. 11 is a view illustrating an example of a search target region, which is determined with respect to a region of an already-sensed character by a character search unit of the character string sensing device in order to search the next character;

FIG. 12 is a view illustrating a specific example of the search target region, which is determined with respect to the region of the already-sensed character by the character search unit of the character string sensing device in order to search the next character;

FIG. 13 is a flowchart illustrating flows of image processing and character string sensing processing in the DVD player;

FIG. 14 is a flowchart illustrating a flow of the character string sensing processing performed by the character string sensing device; and

FIG. 15 is a view illustrating a specific example of false sensing.

### DETAILED DESCRIPTION

Hereinafter, embodiments of the present invention will be described with reference to the drawings. In embodiments of the invention, numerous specific details are set forth in order to provide a more thorough understanding of the invention. However, it will be apparent to one with ordinary skill in the art that the invention may be practiced without these specific details. In other instances, well-known features have not been described in detail to avoid obscuring the invention.

The case where a character string sensing device of one or more embodiments of the invention is mounted on a DVD player that reproduces and displays an image will be described below by way of example.

The character string sensing device of one or more embodiments of the invention is not limited to the DVD player, but the character string sensing device can be applied to any image processing device that can process the image. For example, the character string sensing device can be applied to, but is not limited to, various image processing devices such as a digital video recorder/player, a Blu-ray disk player, a digital video camera, a digital camera, a digital television set, a personal computer, a mobile phone, a printer, and a scanner which process a still image and/or a moving image. Hereinafter both the still image data and the moving image data are referred to as an image.

[Configuration of DVD Player 1]

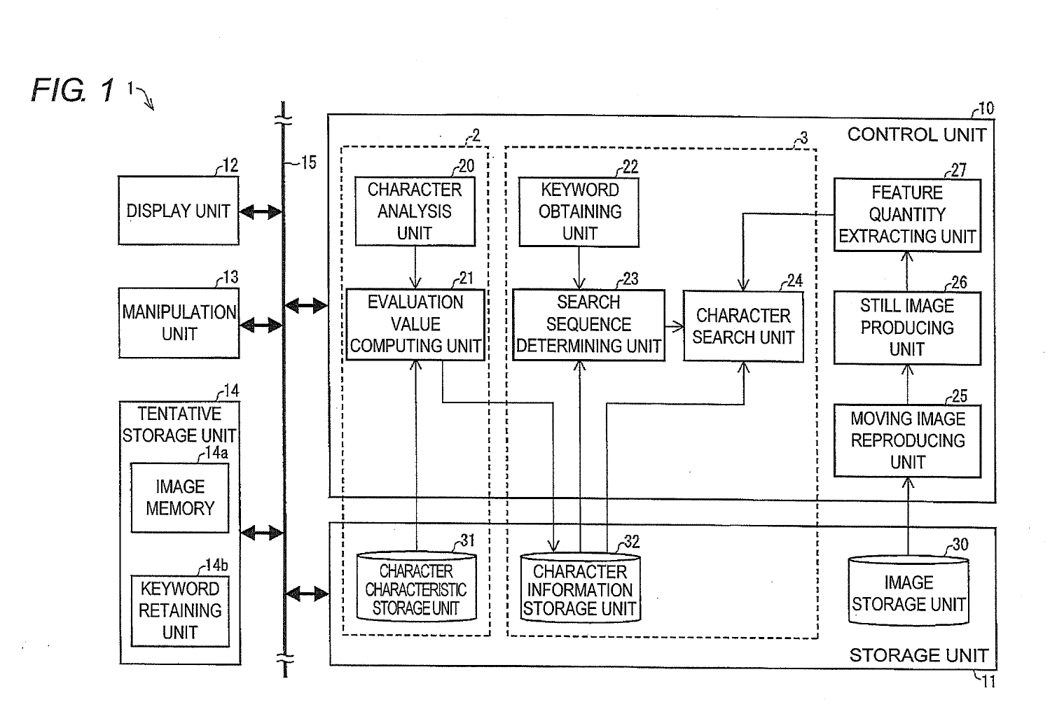

FIG. 1 is a block diagram illustrating a configuration of a main part of a DVD player 1 according to an embodiment of the invention.

As illustrated in FIG. 1, the DVD player (image processing device) 1 of an embodiment includes a control unit 10, a storage unit 11, a display unit 12, a manipulation unit 13, a tentative storage unit 14, and a bus 15. The bus 15 is a common signal line through which data is transmitted and received among the units.

The image processed by the DVD player 1 is displayed on the display unit 12, or a manipulation screen used to manipulate the DVD player 1 by a user is displayed as a GUI (Graphical User Interface) screen on the display unit 12. The display unit 12 is formed by a display device such as an LCD (Liquid Crystal Display) and an organic EL display.

The manipulation unit 13 is used when the user inputs an instruction signal to the DVD player 1 to manipulate the DVD player 1.

The DVD player 1 may include the display unit 12 and manipulation unit 13, which can directly transmit and receive the data through the bus 15. However, the DVD player 1 is not limited to the configuration of an embodiment.

In one or more embodiments, the display unit 12 is implemented by a digital television set, an external interface (not illustrated) of the DVD player 1 is connected to the control unit 10 through the bus 15, and the external interface is connected to the display unit 12 that is of the digital television set through an HDMI (High Definition Multimedia Interface) terminal and an HDMI cable. Therefore, the DVD player 1 outputs the image reproduced thereby to the display unit 12 to display the image on the display unit 12.

In one or more embodiments, the manipulation unit 13 may be implemented as a remote controller common to the digital television set and the DVD player 1 by way of example. A signal corresponding to a button (such as a cross key, a determination key, and a character input key) provided in the manipulation unit 13 is output in the form of an infrared signal from a light emitting portion of the manipulation unit 13 when the button is pressed, and the signal is input to the DVD player 1 or digital television set through a light receiving portion that is provided in a main body of the DVD player 1 or digital television set. The signal received through the light receiving portion (not illustrated) of the DVD player 1 is supplied to the control unit 10 through the bus 15, and the control unit 10 performs an operation according to the signal.

The control unit 10 executes a program that is read from the storage unit 11 to the tentative storage unit 14, thereby performing various computations and wholly controlling each unit of the DVD player 1 through the bus 15.

In one or more embodiments, the control unit 10 includes at least a keyword obtaining unit 22, a search sequence determining unit 23, and a character search unit 24 as functional blocks. Each of the functional blocks is used to cause the DVD player 1 to act as a character string sensing device 3 of one or more embodiments of the invention.

Because the DVD player 1 is an image processing device, the control unit 10 includes functional blocks used to cause the DVD player 1 to act as the image processing device. The functional blocks include a moving image reproducing unit 25, a still image producing unit 26, and a feature quantity extracting unit 27. The configuration of an embodiment is an example of the functional blocks that are basically included in the image processing device. The configuration of the character string sensing device 3 of one or more embodiments of the invention is not limited to the configuration of an embodiment, but the functional blocks are appropriately designed according to a function of the image processing device.

A character evaluating device 2 of one or more embodiments of the invention can also be mounted on the DVD player 1 of one or more embodiments. The character evaluating device 2 analyzes and evaluates any character that can be sensed by the character string sensing device 3, and the character string sensing device 3 can sense the character string included in the image using the information on the character that is evaluated and obtained by the character evaluating device 2.

The control unit 10 includes a character analysis unit 20 and an evaluation value computing unit 21 as functional blocks that cause the DVD player 1 to act as the character evaluating device 2.

Each of the functional blocks (20 to 27) of the control unit 10 can be realized such that a CPU (central processing unit) reads a program stored in a storage device implemented by a ROM (Read Only Memory) or the like to the tentative storage unit 14 implemented by a RAM (Random Access Memory) or the like to execute the program.

A control program and an OS program, which are executed by the control unit 10, and various pieces of fixed data, which are read by the control unit 10 in performing various functions (such as image processing, character string sensing processing, and character evaluation processing) possessed by the DVD player 1, are stored in the storage unit 11. In one or more embodiments, for example, the storage unit 11 includes an image storage unit 30, a character characteristic storage unit 31, and a character information storage unit 32, and various pieces of fixed data are stored in the storage unit 11. For example, the storage unit 11 is implemented by a rewritable nonvolatile memory such as an EPROM (Erasable ROM), an EEPROM (Electrically EPROM), and a flash memory. As described above, the storage unit in which information whose contents are not rewritten is stored may be implemented by ROM as read only semiconductor memory (not illustrated) that is different from the storage unit 11.

The target image data that is processed by the DVD player 1 as the image processing device is stored in the image storage unit 30. In one or more embodiments, both the still image and the moving image can be stored as the image in the image storage unit 30.

Character characteristic information is stored in the character characteristic storage unit 31. The character characteristic information is information on a character characteristic that the evaluation value computing unit 21 uses to evaluate the character. The character characteristic information is described in detail later.

Character information that the character string sensing device 3 uses to perform the character string sensing processing is stored in the character information storage unit 32 while a database of the character information is compiled. In the character database stored in the character information storage unit 32, a character code used to uniquely discriminate a character, a feature quantity of the character, and the evaluation value of the character are stored in each character while correlated with one another. A data structure of the character database is described in detail later.

The tentative storage unit 14 is a so-called working memory in which data used in computation and computation result are tentatively stored in processes of various pieces of processing performed by the DVD player 1, and the tentative storage unit 14 is implemented by the RAM (Random Access Memory) or the like. More specifically, the still image producing unit 26 expands the image that becomes the processing target in an image memory 14a of the tentative storage unit 14 when the image processing is performed, which allows the feature quantity extracting unit 27 to finely analyze the image in units of pixels. When the character string sensing device 3 performs the character string sensing processing based on a keyword input by a user, the input keyword is tentatively stored in a keyword retaining unit 14b of the tentative storage unit 14. Each unit of the character string sensing device 3 appropriately refers to the keyword retaining unit 14b to perform the character string sensing processing for sensing the designated keyword from the image. A data structure of the keyword retaining unit 14b is described in detail later.

The moving image reproducing unit 25 of the control unit 10 reads the moving image stored in the image storage unit 30, and the moving image reproducing unit 25 performs externally outputting processing to the moving image to reproduce the moving image.

When an instruction to reproduce and display the moving image is inputted, the moving image processed by the moving image reproducing unit 25 is tentatively stored in the image memory 14a, and the moving image is output in each frame to the display unit 12 under the control of a display control unit (not illustrated).

When an instruction to sense a predetermined character string from the moving image is input, the moving image processed by the moving image reproducing unit 25 is output to the still image producing unit 26.

When an instruction to display the still image stored in the image storage unit 30 is input, the display control unit reads the still image from the image storage unit 30 to output the still image to the display unit 12.

The still image producing unit 26 extracts the target frame to which the character string sensing processing is performed from the frames of the moving image, and the still image producing unit 26 produces the still image of the processing target. The still image producing unit 26 may put all the frames included in the moving image in the still images. However, in one or more embodiments, processing for extracting the still images of the processing targets at predetermined time intervals of seconds or at predetermined intervals of frames.

When an instruction to sense the predetermined character string from the still image is input, the display control unit (not illustrated) reads the designated still image from the image storage unit 30 to output the still image to the feature quantity extracting unit 27.

The feature quantity extracting unit 27 extracts the feature quantity used in the character string sensing processing from the still image produced by the still image producing unit 26 or the still image read by the display control unit. The character string sensing device 3 can use any feature quantity as long as the character string sensing device 3 can discriminate the character shapes of the characters.

However, the character search unit 24 performs the character sensing by comparing the feature quantity to a feature quantity of a well-known model. Accordingly, the feature quantity of the model of each character stored in the character information storage unit 32 and the character feature quantity extracted by the feature quantity extracting unit 27 are extracted by the same technique. For example, the corner detecting technology or the outline (edge) detecting technology, disclosed in Masatoshi Okutomi, et al., “Digital Image Processing”, CG-ARTS Society Press, Mar. 1, 2007 (2nd edition), P. 208 to 210, Section 12-2 “Feature Point Detection”, may be used as the technology of detecting the feature quantity of the character from the image. However, the configuration of the feature quantity extracting unit 27 is not limited to the corner detecting technology or the outline (edge) detecting technology. Alternatively, the feature quantity of the character may be the image of the character.

[Configuration of Character Evaluating Device 2]

The character evaluating device 2 (FIG. 1) of one or more embodiments of the invention evaluates the character to output the evaluation value of each character. Particularly, the character evaluating device 2 analyzes the character based on a shape characteristic of the character and a linguistic characteristic of the character, and the character evaluating device 2 evaluates how much the character is hardly falsely sensed (how much the character is easily correctly sensed), thereby determining the evaluation value expressing “difficulty of false sensing”. The evaluation value of each character is previously stored in the character information storage unit 32.

The character string sensing device 3 can previously understand the difficulty of false sensing of each character using the evaluation value determined by the character evaluating device 2. Therefore, the character string sensing device 3 can perform the search in the order from the hardly-falsely-sensed character in the keyword, and the character string sensing processing can efficiently be realized than ever before.

As used herein, the false sensing means that the character string sensing device falsely senses that the target character is included in a background region that is not the character, the character string sensing device falsely senses that another character is the target character, and the character string sensing device fails to sense the target character in spite of existence of the target character. The false sensing is easily generated in the character having the simple shape and the character having a different notation character. For example, a probability of the false sensing is enhanced, when the character has few character-like characteristic shapes (such as a numeral “1” and “ [symbol] ” expressing prolonged sound), when the character is frequently used as part of the element of various characters such as a radical index of the kanji character (such as “ [symbol] ” and “ [symbol] ”), when the characters have shapes similar to each other although the characters different from each other (such as katakana “ [symbol] ” and Chinese numeral “ [symbol] ”, katakana “ [symbol] ” and kanji character “ [symbol] ”, and usual “ [symbol] ” and “ [symbol] ” expressing a double consonant), and when the character has plural notations while having one meaning (such as “ [symbol] ” and “ [symbol] ”, “A” and “a”).

The “difficulty of false sensing” can be evaluated by the complicated shape of the character, absence of the similar-shape character, and absence of the different notation character. Alternatively, other features of the character shape and other character characteristics may be used to evaluate the difficulty of false sensing.

From the above-described viewpoints, the character evaluating device 2 evaluates the character based on the character shape and the linguistic characteristic of the character. The configuration of the character evaluating device 2 will be described in detail below.

The character analysis unit 20 of the control unit 10 analyzes the character shape. In one or more embodiments, the character analysis unit 20 recognizes that the character is formed by at least one line element, and the character analysis unit 20 detects the element from the character shape. The element detected by the character analysis unit 20 may be a straight line or a curved line, or the element may be detected as the straight line by which the curved line is approximated. The character analysis unit 20 classifies the detected elements to decompose the character according to an orientation of the detected element (line) or the straight line or curved line.

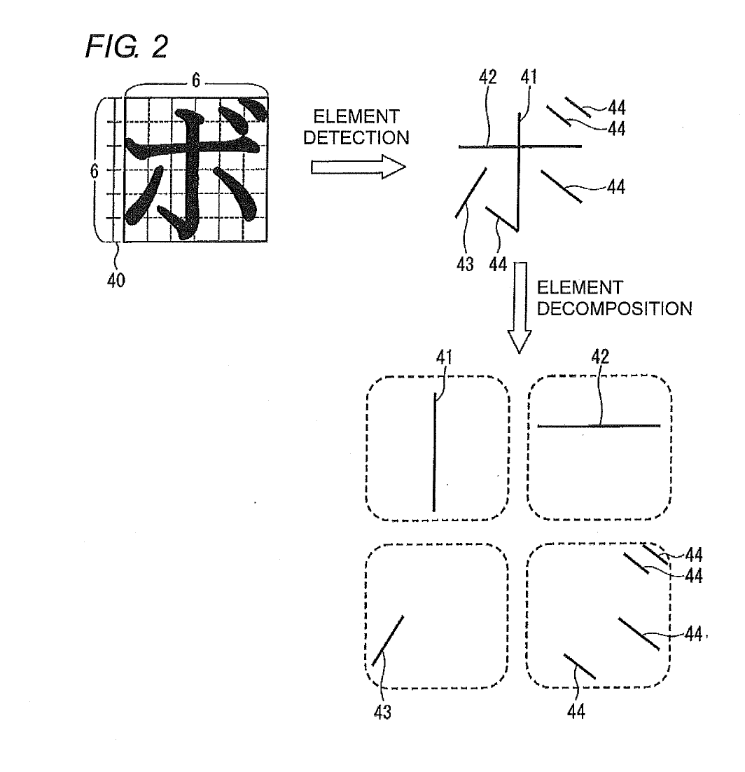

FIG. 2 is a view illustrating examples of character element detecting processing and character element decomposing processing, which are performed by the character analysis unit 20.

The evaluation target character to be evaluated is input to the character evaluating device 2. At this point, by way of example, it is assumed that the character that is of katakana “ [symbol] ” is input from the manipulation unit 13 to the character evaluating device 2. The character may be input in any mode as long as the character evaluating device 2 can recognize that the input character is the katakana “ [symbol] ”. For example, the character “ [symbol] ” may be input as text data, a image, a character code, or sound.

When obtaining the evaluation target character “ [symbol] ”, the character analysis unit 20 normalizes the character into a constant size. In the example illustrated in FIG. 2, the size of the character “ [symbol] ” is normalized using a scale 40 so as to be accommodated in a 6-by-6 frame in a balanced manner. Therefore, only the character shape can correctly be analyzed while a variation of the size in inputting the evaluation target character is ignored

Then the character analysis unit 20 detects the element from the character “ [symbol] ” unified by the scale 40. In the example illustrated in FIG. 2, the curved line is approximated by the straight line to detect all the elements as a straight line (41 to 44). There is no particular limitation to the method for detecting the line from the character shape, but well-known image processing techniques can appropriately be adopted. For example, the corner detecting technology or the outline (edge) detecting technology can be used as the method for detecting the line from the character shape (see Masatoshi Okutomi, et al., “Digital Image Processing”, CG-ARTS Society Press, Mar. 1, 2007 (2nd edition), P. 208 to 210, Section 12-2 “Feature Point Detection”).

Then the character analysis unit 20 classifies all the detected elements according to the kind or orientation of the line to decompose the element. Although an example is illustrated in FIG. 2, one or more embodiments of the invention are not limited to the example illustrated in FIG. 2. For example, because the character analysis unit 20 detects seven straight-line elements from the character “ [symbol] ”, the character analysis unit 20 classifies the elements into four groups of a vertical line 41, a horizontal line 42, a diagonally-right-up line 43, and a diagonally-right-down line 44. Therefore, the character analysis unit 20 decomposes the character “ [symbol] ” into the total of seven elements (lines), that is, one vertical line 41, one horizontal line 42, one diagonally-right-up line 43, and four diagonally-right-down lines 44. The scale 40 is effectively used for lengths of the decomposed elements (lines).

The character analysis unit 20 determines a characteristic value relating to the shape of the evaluation target character using the analysis result of the evaluation target character (in this case, “ [symbol] ”). The characteristic value means the character characteristic expressed by a numerical value or a value of a rank, and the characteristic value is used to compute the evaluation value. In one or more embodiments, the character analysis unit 20 determines two kinds of characteristic values relating to the shape, that is, “element length” and “different orientation property” from the analysis result.

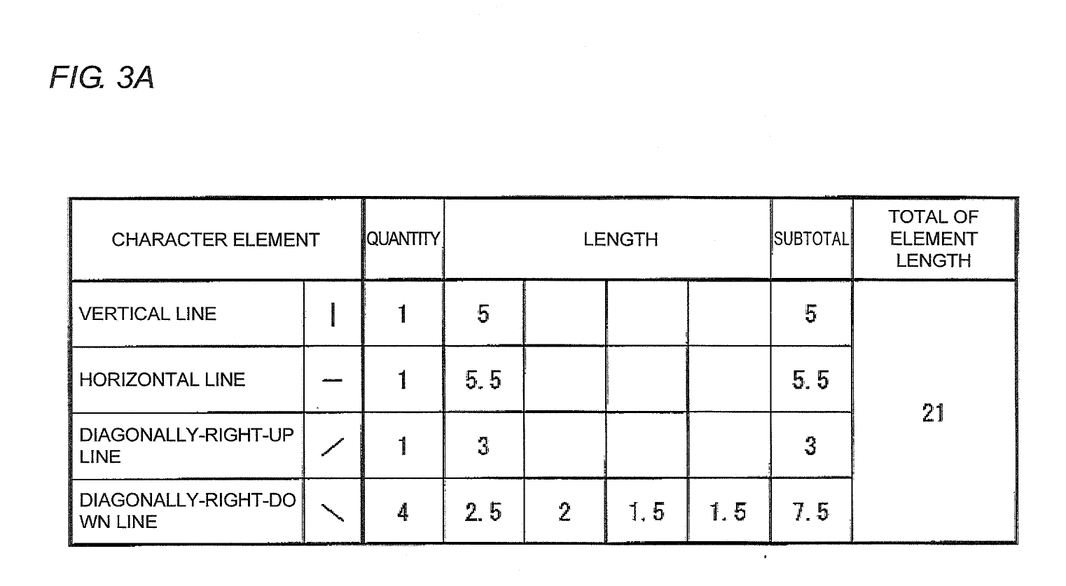

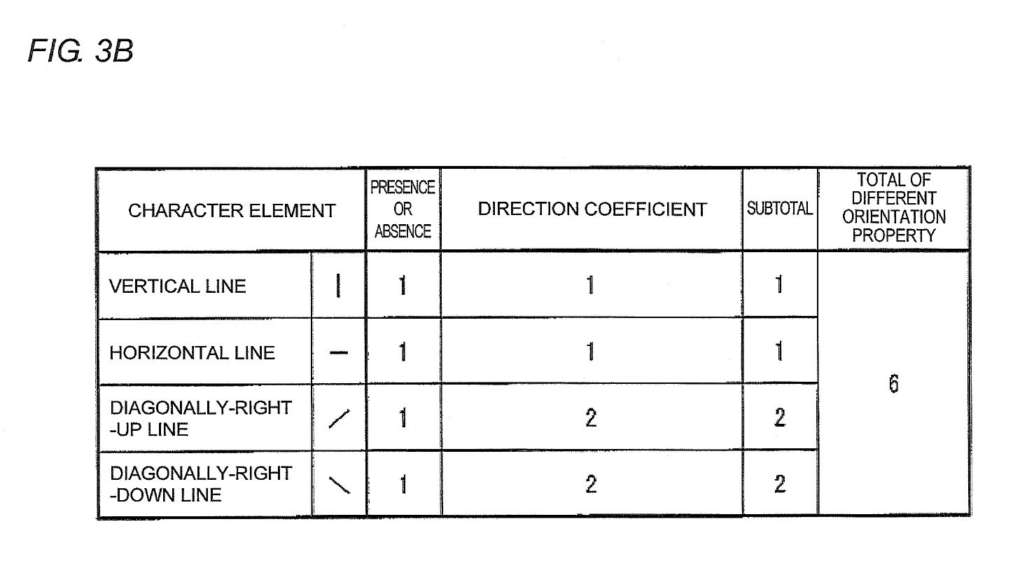

FIG. 3A and FIG. 3B are views illustrating specific examples of characteristic values on a shape, which is determined by the character analysis unit 20. FIG. 3A and FIG. 3B illustrate examples in which the character analysis unit 20 determines the “element length” and “different orientation property” of the character “ [symbol] ” based on the analysis result of the character “ [symbol] ”, obtained along the procedure illustrated in FIG. 2.

(Computation of Element Length)

The characteristic value of “element length” expresses a length of all the elements (lines) possessed by the character. As the number of lines used in the configuration of the character increases, the element length increases. Accordingly, a decision that the character is more complicated (hardly falsely sensed) as the number of lines constituting the character increases can be made.

As described above, the length of each decomposed line can be expressed using the scale 40 that is used in normalizing the character.

As a result of the analysis, because the character “ [symbol] ” is classified into the four groups of the vertical line 41, the horizontal line 42, the diagonally-right-up line 43, and the diagonally-right-down line 44, the character analysis unit 20 subtotals the line lengths in each group. In the example illustrated in FIG. 3A, the subtotal “5” of one line having a length “5” for the vertical line 41, the subtotal “5.5” of one line having a length “5.5” for the horizontal line 42, the subtotal “3” of one line having a length “3” for the diagonally-right-up line 43, and the subtotal “7.5” of four lines having lengths “2.5”, “2”, “1.5”, and “1.5”, respectively, for the diagonally-right-down line 44.

Finally the character analysis unit 20 sums up the subtotals of the line lengths of all the groups to determine the element length “21” of the character “ [symbol] ”. At this point, the numeric character “1” corresponds to the length of one grid of the scale 40.

Assuming that X is a subtotal of the lengths of the vertical lines, Y is a subtotal of the lengths of the horizontal lines, and Z is a subtotal of the lengths of the diagonal lines (diagonally-right-up line and diagonally-right-down line), the element length may be computed from the following equation:

characteristic value “element length”=X+Y+kZ(k>1)

That is, the equation has a configuration in which a weight coefficient is added to the lengths of the diagonal lines rather than the lengths of vertical and horizontal lines. For example, in the example illustrated in FIG. 3, assuming that a weight coefficient k is set to 2, the vertical line 41, the horizontal line 42, the diagonally-right-up line 43, and the diagonally-right-down line 44 have the subtotals “5”, “5.5”, “6”, and “15”, respectively, and the character “ [symbol] ” has the element length “31.5”.

According to the configuration, the decision that the character in which the number of diagonal lines is larger than the number of vertical and horizontal lines (horizontal line or vertical line) is the complicated (hardly falsely sensed) can be made.

(Computation of Different Orientation Property)

The characteristic value of “different orientation property” expresses versatility of the orientations of the lines constituting the character. The decision that the character having lines oriented in the increased number of directions is complicated can be made. For example, the decision that the character including the vertical line and the horizontal line is more complicated rather than the character including only the horizontal line can be made, and the decision that the character also including the diagonal line is further complicated can be made.

As described above, the decomposed lines of the character “ [symbol] ” are classified into the four groups of the vertical line 41, the horizontal line 42, the diagonally-right-up line 43, and the diagonally-right-down line 44 according to the line orientation. The character analysis unit 20 confirms the presence or absence of the line belonging to each group. The character “ [symbol] ” has lines of all the four kinds of the groups, that is, the vertical line is “present”, horizontal line is “present”, the diagonally-right-up line is “present”, and the diagonally-right-down line is “present”. For the character “ [symbol] ”, the vertical line is “present”, the horizontal line is “present”, the diagonally-right-up line is “absent”, and the diagonally-right-down line is “absent” are obtained.

The character analysis unit 20 stores “1” in the column “presence or absence” of the table illustrated in FIG. 3B when the line belonging to the group is “present”, and character analysis unit 20 stores “0” in the column “presence or absence” when the line belonging to the group is “absent”. “1” is stored in the column “presence or absence” because the decision that all the lines are “present” is made for the character “ [symbol] ”. The characteristic value of the different orientation property may be obtained by directly summing up the values of the columns “presence or absence”. In one or more embodiments, a weight is added to the case in which the diagonal line is “present” using a direction coefficient.

In the example illustrated in FIG. 3B, for example, the direction coefficients of the vertical line and horizontal line are previously set to “1” while the direction coefficients of the diagonally-right-up line and diagonally-right-down line are previously set to “2”. The character analysis unit 20 determines the subtotal of the different orientation property in each group from “presence or absence”×“direction coefficient”. Specifically, the subtotal “1” of 1×1 for the vertical line 41, the subtotal “1” of 1×1 for the horizontal line 42, the subtotal “2” of 1×2 for the diagonally-right-up line 43, and the subtotal “2” of 1×2 for the diagonally-right-down line 44 are computed.

Finally the character analysis unit 20 sums up the subtotals of the different orientation properties of all the groups to determine the different orientation property “6” of the character “ [symbol] ”. According to the configuration, the decision that the character including the diagonal line is more complicated than the character including the vertical and horizontal lines can be made.

A threshold is provided with respect to the line length when the character is normalized into the constant size, and the decision that the line of a certain orientation is “absent” may be made when the subtotal of the lengths of the lines in that orientation is lower than a predetermined value.

For example, it is assumed that P is set to 1 when the length of the vertical line is not lower than a predetermined threshold while P is set to 0 when the length of the vertical line is lower than the predetermined threshold, it is assumed that Q is set to 1 when the length of the horizontal line is not lower than a predetermined threshold while Q is set to 0 when the length of the horizontal line is lower than the predetermined threshold, and it is assumed that R is set to 1 when the length of the diagonal line is not lower than a predetermined threshold while R is set to 0 when the length of the diagonal line is lower than the predetermined threshold. The different orientation property may be computed from the following equation:

characteristic value “different orientation property”=P+Q+hR(h>1)

wherein h=2 for one way of the direction (diagonally-right-up line 43 and diagonally-right-down line 44) of the diagonal line, and h=4 for two ways. The predetermined threshold is set to “2”.

In the character “ [symbol] ”, based on the above-described principle, P=1 is obtained because the subtotal of the length of the vertical line is not lower than the predetermined threshold, Q=1 is obtained for the horizontal line in the same manner, and R=1 is obtained for the diagonal line in the same manner. Further, h=4 is obtained because there are two directions for the diagonal line, that is, the diagonally-right-up line and the diagonally-right-up line. Therefore, the different orientation property of 1+1+4×1=6 is computed according to the equation. For example, in the character “ [symbol] ”, P=1 is obtained for the vertical line, Q=1 is obtained for the horizontal line, and R=0 for the diagonal line, 1+1=2 is computed for the characteristic value of the different orientation property.

In computing the “element length” and “different orientation property”, the configuration in which the weight is added to the diagonal line has the following advantage. Generally the numbers of vertical lines and horizontal lines are larger than the number of diagonal lines in the background image (non-character image). Conversely the lines exist densely, and the decision that the diagonal line among the lines has a high possibility of constituting the character can be made. That is, it is said that the character having the diagonal line tends to be easily sensed and hardly falsely sensed. The character is evaluated by adding the weight to the diagonal line rather than the vertical line or horizontal line, which allows the “difficulty of false sensing” of the character to be evaluated more correctly. The use of the evaluation value obtained by the evaluation can shorten the processing time of the character string sensing processing and improve the sensing accuracy.

The thus obtained characteristic value relating to the character shape may tentatively be stored in the tentative storage unit 14 until the evaluation value is finally computed, or the characteristic value determined once may be stored by each character in the character characteristic storage unit 31 in a nonvolatile manner.

The characteristic value relating to the character shape is not limited to one embodiment. For example, the number of elements (lines) may be used as the characteristic value, or a stroke count may be used as the characteristic value.

The character analysis unit 20 may perform the character analysis to input one character, or the character analysis unit 20 may perform the character analysis to each of all the characters constituting the keyword when the keyword is input.

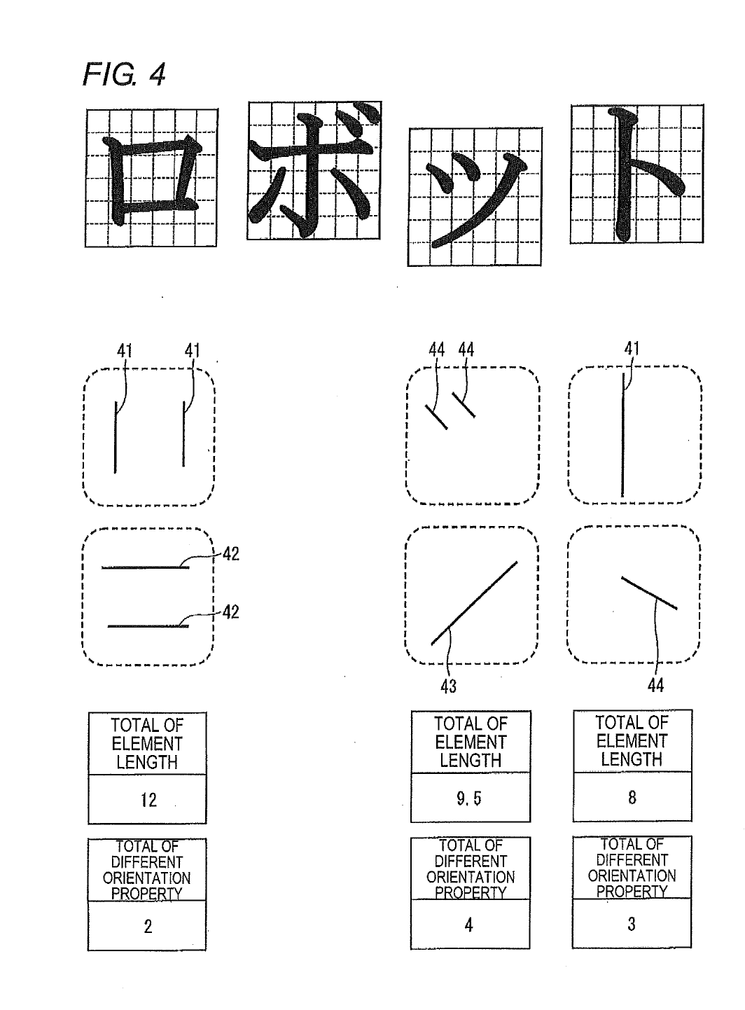

FIG. 4 is a view illustrating an example of result in which the character analysis unit performs character analysis to plural characters. For example, when the character string “ [symbol] ” is input to the character evaluating device 2, similarly to the character “ [symbol] ”, the character analysis unit 20 detects the element from the character shape to decompose the element for the characters “ [symbol] ”, “ [symbol] ”, and “ [symbol] ” as illustrated in FIG. 4. In FIG. 4, the analysis result of the character “ [symbol] ” is omitted because the analysis result is described as illustrated in FIG. 2 and FIGS. 3A and 3B.

The evaluation value computing unit 21 computes the evaluation value (difficulty of false sensing) of the evaluation target character using the characteristic value of the character shape, computed by the character analysis unit 20, and/or the characteristic value that is obtained from the character characteristic information stored in the character characteristic storage unit 31.

All information on character characteristic except the character characteristic relating to the shape obtained by the analysis of the character analysis unit 20 are stored in the character characteristic storage unit 31. In one or more embodiments, for example, the evaluation value computing unit 21 specifies a characteristic value of “ease of discrimination” and a characteristic value of “notation uniformity” of the evaluation target character based on the character characteristic information stored in the character characteristic storage unit 31.

(Specification of Ease of Discrimination)

The characteristic value of “ease of discrimination” expresses ease of discrimination in which the character is correctly discriminated without mistaking the character for another character (or confusing the character with the non-character region). It is said that the false sensing is easily generated because the ease of discrimination is low, when the character has the geometrically simple shape, and has few characteristic shapes, when the character is frequently used as a part of various character elements such as the radical index of the kanji character, or when the character is similar to another character.

In one or more embodiments, the ease of discrimination is previously defined from past experiences. For example, the numerical value is set such that the confusing character has the low value of the ease of discrimination according to a ratio of the past false sensing, an appearance frequency at which the character becomes a apart of another character as the radical index (“left-hand side” of kanji character or “right-hand side” of kanji character), and how many characters having shapes similar to that of the character.

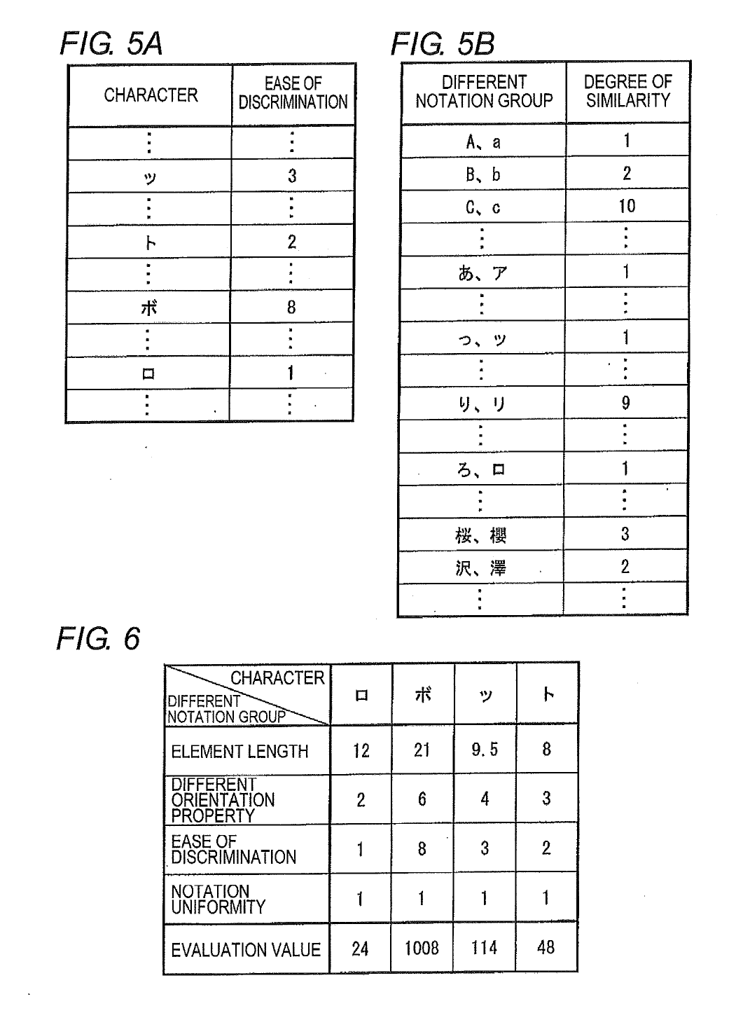

FIG. 5A is a view illustrating a specific example of character characteristic information on the ease of discrimination, which is stored in a character characteristic storage unit 31. In the example illustrated in FIG. 5A, each character is stored while correlated with the characteristic value of the ease of discrimination. As illustrated in FIG. 5A, the character characteristic information may be the characteristic value of the “ease of discrimination”. Alternatively, another piece of processing may be performed to the character characteristic information, so that the characteristic value may finally be specified.

In one or more embodiments, for example a definition range of the ease of discrimination is set to 0<“ease of discrimination”≦10. The character which is more confusable with another character is set to a value closer to 0. For example, a katakana “ [symbol] ” is similar to a kanji character “ [symbol] ”, and the katakana “ [symbol] ” is also similar to a geometrical shape of tetragon that is not the character. The “left-hand side” of a kanji character “ [symbol] ” and the “right-hand side” of a kanji character “ [symbol] ” are the character having a probability of emerging as a part of another character. Accordingly, for example, the ease of discrimination of the katakana “ [symbol] ” is set to “1”. On the other hand, the katakana “ [symbol] ” is more complicated than the katakana “ [symbol] ”, the katakana “ [symbol] ” has no character having the similar shape, and the katakana “ [symbol] ” has a small probability of becoming as a part of another character. Therefore, for example, the ease of discrimination of the katakana “ [symbol] ” is set to “8”. Similarly the characteristic value of the ease of discrimination is previously stored for each character. According to the configuration, the evaluation value computing unit 21 can immediately understand the ease of discrimination of the input character by referring to the character characteristic storage unit 31.

(Specification of Notation Uniformity)

The characteristic value of “notation uniformity” expresses the number of characters having the same meanings and different shapes, that is, a minimal notation variation. For the plural notation variations having the shapes largely different from one another, a risk of failing to sense the character is increased when only one kind of the notation is searched.

Accordingly, the character having only one notation is the best, and the character having fewer notation variations is better. Further, the different notation characters having the shapes similar to each other are better. That is, the character is less falsely sensed as the uniformity of the notation of the character is higher.

In one or more embodiments, the evaluation value computing unit 21 specifies the presence or absence of the different notation character with respect to the evaluation target character. When the different notation character is present, the evaluation value computing unit 21 specifies the “notation uniformity” of the character in the definition range of 0<“notation uniformity”≦10 based on the number of different notation variations and a degree of similarity between the different notation characters. The larger value of the “notation uniformity” means that the character has less confusing notations and is less falsely sensed.

FIG. 5B is a view illustrating a specific example of the character characteristic information on the notation uniformity, which is stored in the character characteristic storage unit 31. In the example illustrated in FIG. 5B, in the character characteristic information, the degree of similarity between the characters is correlated in each character group in which the different notation characters exist.

The evaluation value computing unit 21 refers to the table of FIG. 5B to search whether the evaluation target character is included in the different notation group. When the evaluation target character is not included in the different notation group, the evaluation value computing unit 21 specifies the characteristic value of the notation uniformity of the evaluation target character as the maximum value of “10”. When the evaluation target character is included in the different notation group, the evaluation value computing unit 21 refers to the degree of similarity of the character shape between the evaluation target character and the different notation character. For example, the degree of similarity of “10” is the case where the different notation characters are closely similar to each other (for example, a big letter and a small letter of an alphabet “C”). The degree of similarity of “10” is provided to the character group in which the versatility of the notation has no bad influence on the character string sensing processing. The evaluation value computing unit 21 specifies the notation uniformity (characteristic value) of the character as “10” according to the degree of similarity.

For example, four characters “ [symbol] ”, “ [symbol] ”, “ [symbol] ”, and “ [symbol] ” have different notation methods “ [symbol] ”, “ [symbol] ”, “ [symbol] ” and “ [symbol] ”, respectively, and the character shapes are not similar to one another at all. Therefore, the degree of similarity of “1” may be set to the four sets of the different notation character groups. At this point, the evaluation value computing unit 21 specifies all the pieces of notation uniformity of the four characters “ [symbol] ”, “ [symbol] ”, “ [symbol] ”, and “ [symbol] ” as “1” according to the degree of similarity.

According to the configuration, the evaluation value computing unit 21 can obtain the four kinds of the characteristic values relating to the difficulty of false sensing with respect to one evaluation target character. That is, the four kinds of the characteristic value includes the “element length” and “different orientation property” computed by the character analysis unit 20, the “ease of discrimination” stored in the character characteristic storage unit 31, and the “notation uniformity” that is specified from the different-notation-related character characteristic information stored in the character characteristic storage unit 31. Using the four kinds of the characteristic values, the evaluation value computing unit 21 can compute the evaluation value of the character to evaluate the difficulty of false sensing of the character.

In one or more embodiments, the evaluation value computing unit 21 computes the evaluation value using the following equation:

evaluation value=element length×different orientation property×ease of discrimination×notation uniformity

FIG. 6 is a view illustrating an example of the evaluation value computed by the evaluation value computing unit 21. For example, when the character string “ [symbol] ” is input to the character evaluating device 2, as illustrated in FIG. 6, the evaluation value computing unit 21 obtains the four kinds (the element length, the different orientation property, the ease of discrimination, and the notation uniformity) of the characteristic values with respect to each of the four characters “ [symbol] ”, “ [symbol] ”, “ [symbol] ”, and “ [symbol] ”.

The evaluation value computing unit 21 computes the evaluation value of the character “ [symbol] ” to be 12×2×1×1=24 according to the equation. Similarly the evaluation value computing unit 21 computes the evaluation values with respect to the characters “ [symbol] ”, “ [symbol] ”, and “ [symbol] ”. The computed evaluation value is stored in the character information storage unit 32 while correlated with the character, and the character string sensing device 3 can refer to the evaluation value.

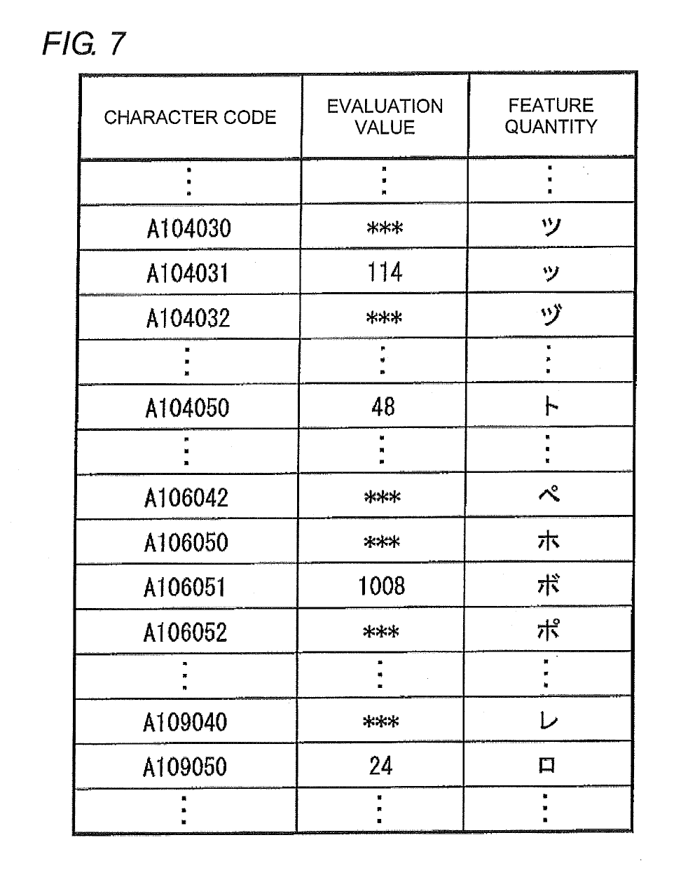

Because the table of the characteristic value of each character, illustrated in FIG. 6, is information in mid-course of the computation of the evaluation value, it is only necessary to be tentatively stored in the tentative storage unit 14. As illustrated in FIG. 7, the table may be deleted after the evaluation value is stored in the character information storage unit 32 in the non-volatile manner. However, when the character evaluating device 2 of the DVD player 1 evaluates the same character many times, the initially-determined characteristic value of the character may be stored in the storage unit 11 in the non-volatile manner.

FIG. 7 is a view illustrating a specific example of a character database stored in the character information storage unit 32.

As illustrated in FIG. 7, the character database of the character information storage unit 32 has a structure in which the character code used to uniquely discriminate the character, the evaluation value computed by the character evaluating device 2, and the character feature quantity used in the character matching processing by the character string sensing device 3 are correlated with one another with respect to each character.

There is no particular limitation to the character feature quantity. Examples of the character feature quantity include the character feature quantity in which the character is recognized as the line element, the character feature quantity in which the outline or edge of the character is detected, and the character feature quantity in which the corner of the character is detected. Alternatively, any piece of information can be used as the character feature quantity as long as the character string sensing device 3 can compare the feature quantity stored in the character database and the feature quantity obtained from the moving image of the sensing target to decide whether the characters are matched with each other.

In the example illustrated in FIG. 7, the character “ [symbol] ” has the evaluation value of “24”, the character “ [symbol] ” has the evaluation value of “1008”, the character “ [symbol] ” has the evaluation value of “114”, and the character “ [symbol] ” has the evaluation value of “48”. Accordingly, when the keyword “ [symbol] ” is input, the character string sensing device 3 can understand the difficulty of false sensing with respect to all the characters in the keyword by referring to the character database of the character information storage unit 32. In the example illustrated in FIG. 7, the character string sensing device 3 can decide that the character “ [symbol] ” is the most-hardly-falsely-sensed character.

[Flow of Character Evaluation Processing]

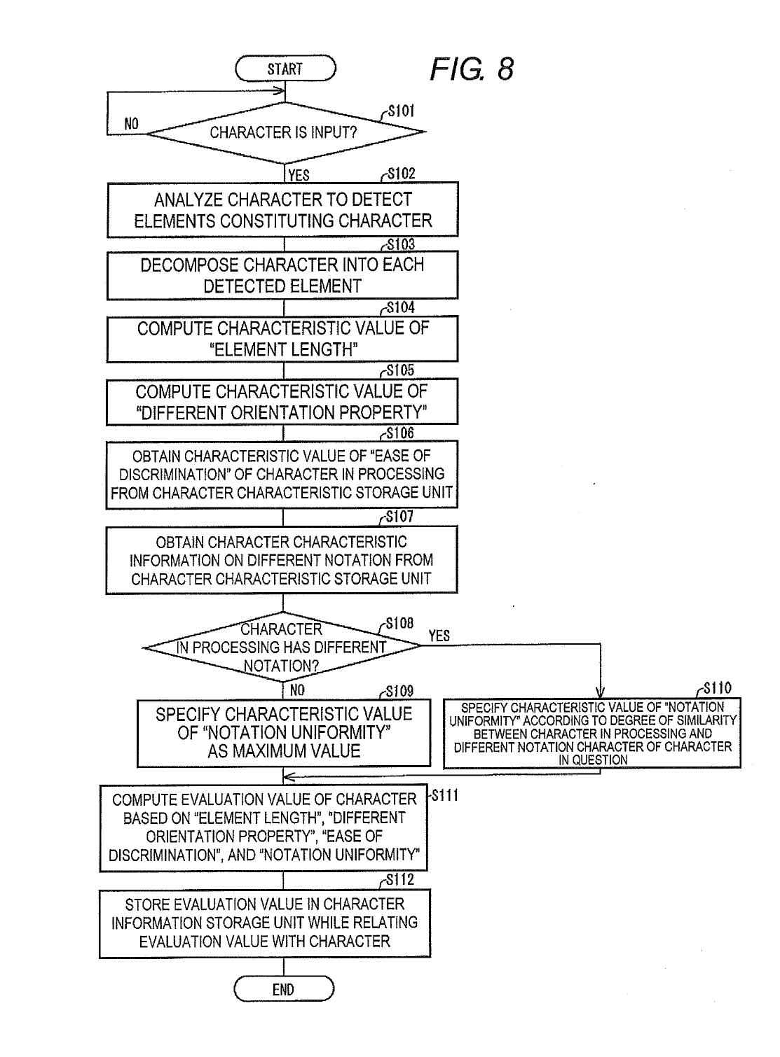

FIG. 8 is a flowchart illustrating a flow of character evaluation processing performed by the character evaluating device 2. The evaluation target character is input to the character evaluating device 2 along with an instruction to evaluate the character. The evaluation target character may be either one character or plural characters.

When the evaluation target character is input (YES in S101), the character analysis unit 20 normalizes the character size on the constant scale to analyze the character shape, and the character analysis unit 20 detects the elements (such as the straight line and the curved line) constituting the character (S102). Then the character analysis unit 20 decomposes the character in each detected element and classifies the elements into the kinds such as the line orientation (S103).

The character analysis unit 20 computes the characteristic value of “element length” based on the length of the decomposed line on the scale (S104). The character analysis unit 20 computes the characteristic value of “different orientation property” based on the versatility of the orientation of the decomposed line (S105).

On the other hand, the evaluation value computing unit 21 refers to the character characteristic storage unit 31 to specify the characteristic value of “ease of discrimination” of the evaluation target character (S106).

The evaluation value computing unit 21 refers also to the character characteristic storage unit 31 to obtain the character characteristic information on the different notation (S107). The evaluation value computing unit 21 decides whether the evaluation target character is included as the different notation group in the obtained character characteristic information (for example, FIG. 5B) (S108).

When deciding that the evaluation target character does not have the different notation character (NO in S108), the evaluation value computing unit 21 specifies the characteristic value of “notation uniformity” of the character as the maximum value (in this case, “10”) (S109). On the other hand, when deciding that the evaluation target character has the different notation character (YES in S108), the evaluation value computing unit 21 specifies the characteristic value of “notation uniformity” according to the degree of similarity between the evaluation target character and the different notation character (S110). For example, when the degree of similarity is “1” (the evaluation target character and the different notation character are not similar to each other), the evaluation value computing unit 21 specifies the characteristic value of “notation uniformity” as “1”.

The evaluation value computing unit 21 computes the evaluation value indicating the difficulty of false sensing based on the four characteristic values determined in the steps, that is, the “element length”, the “different orientation property”, the “ease of discrimination”, and the “notation uniformity” (S111). For example, the evaluation value may be determined by multiplying the characteristic values.

Finally the evaluation value computing unit 21 stores the computed evaluation value in the character information storage unit 32 while correlating the evaluation value with the evaluation target character (S112).

In FIG. 8, the four characteristic values are sequentially determined in S104 to S110 by way of example. However, the determination of the four characteristic values is not limited to the sequence in S104 to S110 of FIG. 8. The four characteristic values may be determined in any order.

According to the configuration and character evaluating method of the character evaluating device 2, the difficulty of false sensing of the character can be evaluated based on the characteristic of the character shape and the linguistic characteristic. When the character string sensing device 3 can previously understand which character is hardly falsely sensed and which character is easily falsely sensed can be previously understood, the character string sensing device 3 can sense the target character string more efficiently from the image in a short time and through the low-load processing.

In one or more embodiments, the character evaluating device 2 previously computes the evaluation value of the character with respect to all the sensing target characters. However, one or more embodiments of the invention are not limited to the configuration of one or more embodiments. For example, after the keyword to be sensed is input to the character string sensing device 3, the character evaluating device 2 may evaluate each character of the input keyword.

A configuration of the character string sensing device 3 that performs the character string sensing processing more efficiently using the evaluation value computed by the character evaluating device 2 will be described in detail below.

[Configuration of Character String Sensing Device 3]

The character string sensing device 3 (see FIG. 1) efficiently performs the character string sensing processing using the evaluation value that is computed in each character by the character evaluating device 2. The character string sensing processing is processing for sensing the designated character string (one character or plural characters) from the moving image or the still image.

The keyword obtaining unit 22 of the control unit 10 obtains the target character string to be sensed along with the instruction to sense the character string.

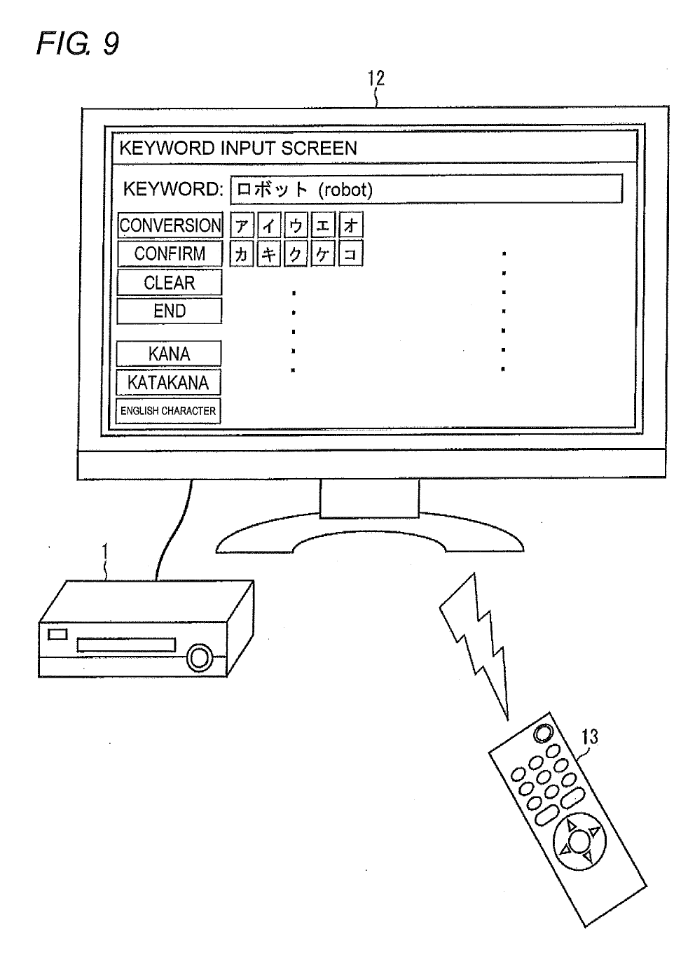

FIG. 9 is a view explaining appearances of a DVD player 1, a display unit 12 (television set), and a manipulation unit 13 (remote controller) of one or more embodiments of the invention and a state in which a user inputs the target character string. In the example illustrated in FIG. 9, the DVD player 1 outputs the manipulation screen to the display unit 12 in order that the user manipulates the character string sensing device 3, and the DVD player 1 causes the display unit 12 to display the manipulation screen. In the example illustrated in FIG. 9, the display unit 12 displays the GUI screen on which the user can manipulate the manipulation unit 13 to input the searched character string.

The user can manipulate the manipulation unit 13 to input the character string that should be found from the processing target moving image (or still image) to the character string sensing device 3. FIG. 9 illustrates the example in which the keyword “ [symbol] ” is input as the target character string.

When the keyword is input and for example, a determination button of the manipulation unit 13 is pressed, the keyword obtaining unit 22 obtains the input keyword (for example, “ [symbol] ”) to store the keyword in the keyword retaining unit 14b of the tentative storage unit 14.

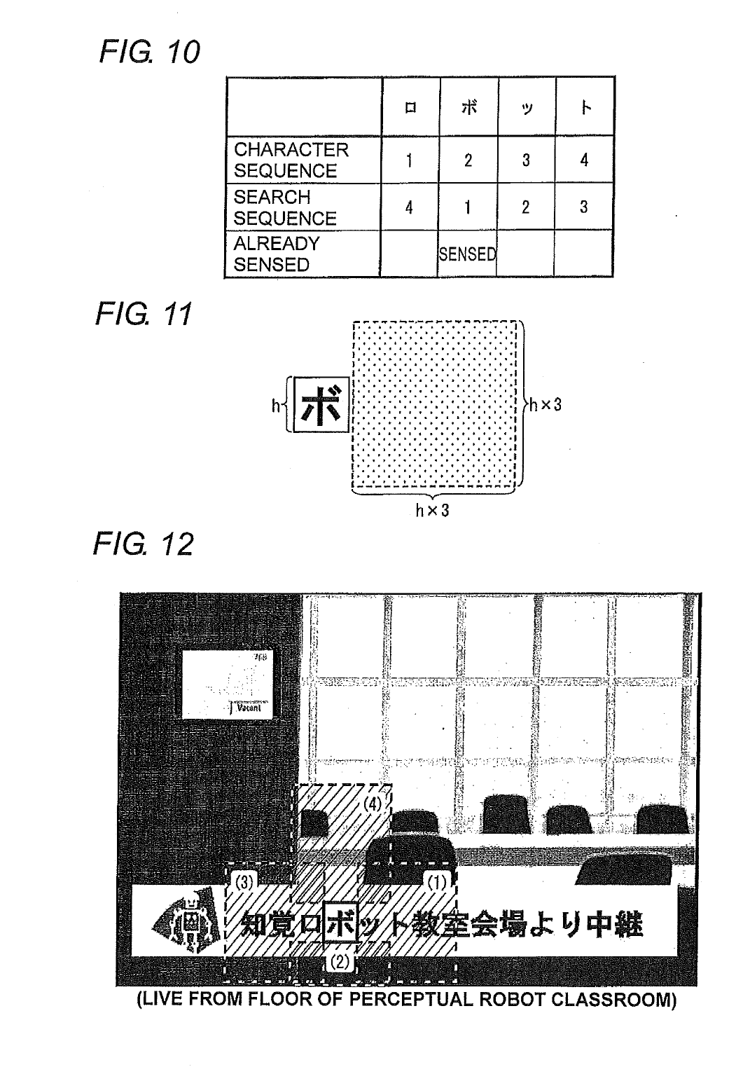

FIG. 10 is a view illustrating an example of a data structure of the keyword retained in the keyword retaining unit 14b. As illustrated in FIG. 10, the keyword obtaining unit 22 stores the characters of the obtained keyword in an alignment sequence of the keyword. For example, for the keyword “ [symbol] ”, [symbol] , because the character “ [symbol] ” is the first character of the keyword, the keyword obtaining unit 22 stores the character “ [symbol] ” while correlating the character “ [symbol] ” with information on a character sequence of “1”. Similarly the keyword obtaining unit 22 stores the characters “ [symbol] ”, “ [symbol] ”, and “ [symbol] ” while correlating the characters “ [symbol] ”, “ [symbol] ”, and “ [symbol] ” with character sequences of “2”, “3”, and “4”.

The search sequence determining unit 23 determines the sequence to search the characters in the keyword when the character search unit 24 searches the keyword from the image. The search sequence determining unit 23 determines the search sequence based on the evaluation value computed by the character evaluating device 2. Specifically, the character having a higher evaluation value is set to a higher position in the search sequence of the character such that the character string sensing processing is performed to the hardly-falsely-sensed (that is, easily-correctly-sensed) character.

When the keyword “ [symbol] ” is input, the search sequence determining unit 23 obtains the evaluation values of the characters “ [symbol] ”, “ [symbol] ”, “ [symbol] ”, and “ [symbol] ” by referring to the character database of the character information storage unit 32 illustrated in FIG. 7. Because the characters have the evaluation values of “24”, “1008”, “114”, and “48”, the search sequence determining unit 23 determines the search sequence, in which the character “ [symbol] ” comes first, the character “ [symbol] ” comes second, the character “ [symbol] ” comes third, and the character “ [symbol] ” comes fourth, such that the characters are searched in the descending order of the evaluation value.

The search sequence determining unit 23 may store the determined search sequence while correlating the search sequence with the input characters as illustrated in FIG. 10.

The character search unit 24 performs the character string sensing processing for sensing the designated character string from the image. The character search unit 24 searches the characters included in the keyword obtained by the keyword obtaining unit 22 in the one-by-one manner. Specifically, the target character feature quantity stored in the character database of the character information storage unit 32 and the feature quantity extracted from the image are compared to each other to sense the matched feature quantity is included in the image, thereby making the decision that the target character is included in the image.

In one or more embodiments, when searching the characters of the keyword, the character search unit 24 performs the character string sensing processing according to the search sequence determined by the search sequence determining unit 23. For example, the character search unit 24 refers to the search sequence (see FIG. 10) stored in the keyword retaining unit 14b, and the character search unit 24 searches the target character from the processing target image in the sequence of the characters “ [symbol] ”, “ [symbol] ”, “ [symbol] ” and “ [symbol] ”.

The character search unit 24 performs the search from the most-hardly-falsely-sensed character “ [symbol] ”, and the character search unit 24 continuously searches the next character when the character “ [symbol] ” can be sensed. For example, as illustrated in FIG. 10, a flag of “sensed” indicating the already-sensed character may be provided to the character that is already sensed. Then the character search unit 24 searches the character having the highest search sequence in the characters that are not sensed yet, and the character search unit 24 repeats the search.

When the character “ [symbol] ” cannot be sensed, the character search unit 24 decides that the designated keyword “ [symbol] ” is not included in the image. Because the character string sensing processing is performed in the order from the hardly-falsely-sensed character, the decision is made quickly and correctly, and the time-consuming, wasted character string sensing processing for sensing the subsequent easily-falsely-sensed characters can be omitted.

After successfully sensing at least one character, the character search unit 24 predicts a positional relationship between the characters based on the character alignment of the already-sensed character and the character to be sensed, and the character search unit 24 narrows the search target region to the neighboring region of the already-sensed character to perform the character string sensing processing.

Particularly, when the already-sensed character is an nth character in the character string while the next searched character is an (n+1)th character in the character string, the character search unit 24 does not set the search target region to the whole image, but can restrict the search target region to the region having a predetermined size located on the right of and below the already-sensed character. When the next searched character is an (n−1)th character in the character string, the character search unit 24 can restrict the search target region to the region having a predetermined size located on the left of and above the already-sensed character.

According to the configuration, the search range can be narrowed compared with the case where the target character is searched from the whole image region, so that the processing time can further be shortened.

A specific example will be described below. It is assumed that the character search unit 24 searches the character “ [symbol] ” after searching the character “ [symbol] ” having the first search sequence. Referring to the character sequence illustrated in FIG. 10, the next searched character “ [symbol] ” has the third character sequence while the already-sensed character “ [symbol] ” has the second character sequence. Accordingly, the character “ [symbol] ” has the high possibility of existing in the neighboring region (particularly, on the right of or below the character “ [symbol] ” in Japanese) of the character “ [symbol] ”.

Therefore, the character search unit 24 restricts the target region where the character “ [symbol] ” is searched to the neighboring region of the already-sensed character “ [symbol] ”. For example, as illustrated in FIG. 11, the character search unit 24 restricts the target region to the region having the predetermined size on the right of the character “ [symbol] ” (hatched region in a broken-line frame). For example, as illustrated in FIG. 11, assuming that the already-sensed character “ [symbol] ” has a region size of h×h, the predetermined size is restricted to a 3 h-by-3 h region located on the right of the character “ [symbol] ”.

In the example illustrated in FIG. 12, the target character (for example, character “ [symbol] ”) is sensed in a region (1) on the right of the already-sensed character (for example, character “ [symbol] ”). When the search target region is restricted, the target character “ [symbol] ” can be sensed in a considerably shorter time and with a considerably lower load compared with the case where the whole image is searched.

When the target character (for example, character “ [symbol] ”) is not found in the region (1) on the right of the already-sensed character (for example, character “ [symbol] ”), the search is continuously performed by sequentially spreading the search target region to a region (2) below the character “ [symbol] ”, a region (3) on the left of the character “ [symbol] ”, and a region (4) above the character “ [symbol] ”, in which the target character is possibly found. However, when the target character is not found even so, finally the search is performed again while the search target region is returned to the whole image.

According to the configuration, the processing efficiency of the character string sensing processing can dramatically be improved in the character search unit 24.

As a distance between the already-sensed character and the next searched character is lengthened like distance between an nth already-sensed character and next searched characters having (n±2)th, (n±3)th, (n±4)th, . . . character sequences, the character search unit 24 may predict the positional relationship between the already-sensed character and the next searched character to further expand the search target region according to the positional relationship.

For example, in the example illustrated in FIG. 12, when the character “ [symbol] ” of the keyword “ [symbol] ” is sensed after the character “ [symbol] ” is sensed, assuming that the already-sensed character “ [symbol] ” has a region size of h×h, the region where the character “ [symbol] ” is searched is restricted to the 6 h-by-6 h region located on the right of the already-sensed character “ [symbol] ”.

Even in the case, an area of the search target region can largely be restricted compared with the case where the search target region is set to the whole image, and the reduction of the processing load and the shortening of the processing time can be realized.

The character search unit 24 detects a belt-like region where the lines and edges are densely located from the feature quantity obtained from the image. When the belt-like region extends horizontally, the character search unit 24 decides that probably the character is the horizontal writing, and the character search unit 24 preferentially searches the horizontal region rather than the vertical region. When the belt-like region extends vertically, the character search unit 24 decides that probably the character is the vertical writing, and the character search unit 24 preferentially searches the vertical region rather than the horizontal region.

According to the configuration, the processing efficiency can further be improved in the character search unit 24.

When the character search unit 24 searches another character after searching the character (for example, character “ [symbol] ”) in the character string, the character search unit 24 may preferentially search the character (in this case, character “ [symbol] ”) having the larger evaluation value in the characters (in this case, characters “ [symbol] ” and “ [symbol] ”) on both sides of the detected character.

[Flow of Character String Search Processing]

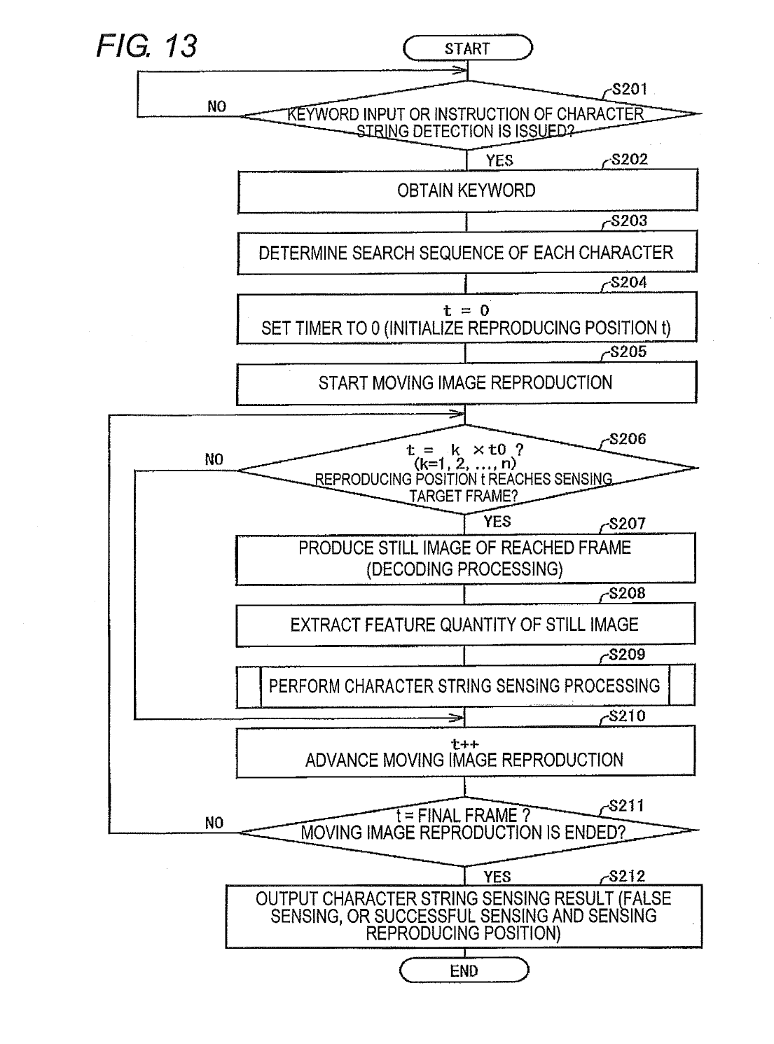

FIG. 13 is a flowchart illustrating flows of image processing and character string sensing processing in the DVD player 1. It is assumed that the character string sensing device 3 searches the designated keyword from the moving image to output a reproducing position at which the target keyword is sensed. The instruction to sense the character string is issued to the character string sensing device 3, and the target character string (for example, keyword “ [symbol] ”) to be searched is input to the character string sensing device 3. The search target character string may be either one character or plural characters. The moving image of the sensing target may be designated at this point.

When the keyword is input (YES in S201), the keyword obtaining unit 22 stores the input keyword in the keyword retaining unit 14b (S202). At this point, the keyword obtaining unit 22 stores the keyword and the character sequence obtained according to the character alignment in the keyword retaining unit 14b while correlating the keyword with the character sequence.

Then the search sequence determining unit 23 refers to the character information storage unit 32 to obtain the evaluation value with respect to each character of the keyword obtained by the keyword obtaining unit 22. The search sequence determining unit 23 determines the character sequence in the descending order of the evaluation value (S203). The search sequence determining unit 23 stores the determined search sequence of each character in the keyword retaining unit 14b.

The moving image reproducing unit 25 reads the moving image of the designated sensing target from the image storage unit 30, the moving image reproducing unit 25 initializes a reproducing position t (t is set to 0) (S204), and the moving image reproducing unit 25 starts to reproduce the moving image (S205).

In one or more embodiments, from the viewpoint of the processing efficiency, the character string sensing processing is not performed to all the frames of the moving image, but the frames extracted at predetermined time intervals of seconds (for example, t0 seconds) are used as the search target frame.

The moving image reproducing unit 25 reproduces the moving image, and the moving image reproducing unit 25 advances the reproduction of the moving image (S210) until the reproducing position t reaches the search target frame (NO in S206). The reproduction of the moving image can be advanced as long as the reproducing position t does not reach the final frame of the moving image (NO in S211). When the reproducing position t reaches the search target frame with progression of the reproducing position t (YES in S206), the still image producing unit 26 produces the still image of the reached search target frame (decoding processing)(S207).

The feature quantity extracting unit 27 extracts the feature quantity from the produced still image (S208). The feature quantity is information that is obtained by the corner detecting technology or the outline (edge) detecting technology, disclosed in Masatoshi Okutomi, et al., “Digital Image Processing”, CG-ARTS Society Press, Mar. 1, 2007 (2nd edition), P. 208 to 210, Section 12-2 “Feature Point Detection”, and the feature quantity is information with which the character string sensing device 3 can discriminate the character shapes.

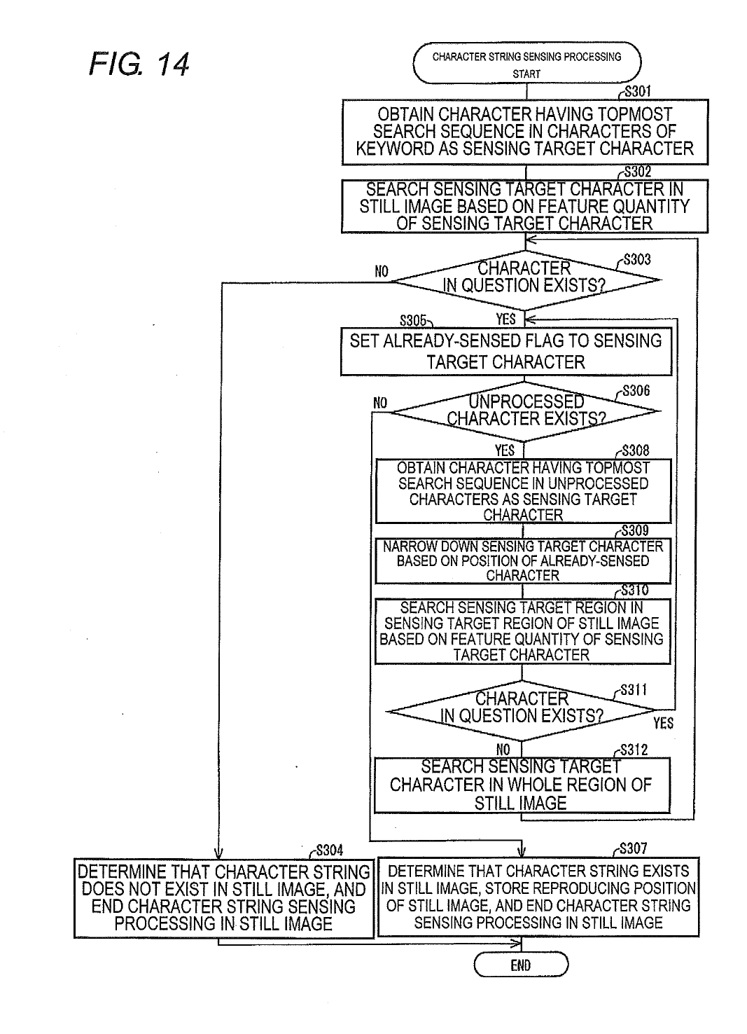

The character search unit 24 performs the character string sensing processing to the search target frame (S209). Particularly, the character search unit 24 performs matching processing of the feature quantity of the search target frame and the feature quantity of each character in the keyword stored in the character information storage unit 32 to decide whether the designated keyword (for example, “ [symbol] ”) is included in the search target frame. The detailed flow of the character string sensing processing is described later with reference to FIG. 14. The character search unit 24 performs the search in each character, and the character search unit 24 outputs whether the designated keyword is sensed with respect to the search target frame.

When the character string sensing processing is ended with respect to the search target frame in S209, the moving image reproducing unit 25 further advances the reproduction of the moving image (S210). The moving image reproducing unit 25 can advance the reproduction of the moving image as long as the reproducing position t does not reach the final frame of the moving image (NO in S211). When the reproducing position t reaches the next search target frame, the character string sensing processing is performed to the search target frame. After that, the character search unit 24 performs the character string sensing processing to the search target frame at predetermined time intervals of seconds (t0 seconds), and the character search unit 24 stores the reproducing position of the frame in which the keyword “ [symbol] ” is sensed.

Finally, when the reproducing position t reaches the final frame to end the reproduction of the moving image (YES in S211), the character search unit 24 outputs the result of the character string sensing processing (S212). For example, when the keyword “ [symbol] ” is not sensed in the moving image, the character search unit 24 outputs a message of false sensing to the display unit 12. On the other hand, when the keyword is sensed in the frame of the moving image, the character search unit 24 outputs a message that the keyword is successfully sensed and a sensing reproducing position corresponding to the frame in which the keyword is sensed to the display unit 12.

[Detailed Flow of Character String Search Processing]

FIG. 14 is a flowchart illustrating a flow of the character string sensing processing performed by the character string sensing device 3. When the feature quantity extracting unit 27 extracts the feature quantity of the search target frame (still image) in S208 of FIG. 13, the character string sensing device 3 starts the character string sensing processing in S209.

The character search unit 24 refers to the keyword retaining unit 14b to obtain the character having the topmost search sequence in the characters of the input keyword as the sensing target character (S301). In the example illustrated in FIG. 10, the character “ [symbol] ” is obtained as the sensing target character.

The character search unit 24 searches the sensing target character “ [symbol] ” with respect to the search target frame (S302) by comparing the feature quantity extracted from the search target frame (still image) and the feature quantity of the character “ [symbol] ” stored in the character information storage unit 32

When the target character (in this case, character “ [symbol] ”) does not exist in the search target frame (NO in S303), the character search unit 24 decides that the designated keyword is not included in the search target frame and ends the character string sensing processing with respect to the search target frame (S304). On the other hand, when the target character (in this case, character “ [symbol] ”) exists in the search target frame (YES in S303), the character “ [symbol] ” is decided as the already-sensed character, and the already-sensed flag is set to the already-sensed character “ [symbol] ” in the keyword retaining unit 14b as illustrated in FIG. 10 (S305). When the character string sensing processing is completed to all the characters of the input keyword (that is, when the already-sensed flags are set to all the characters) (NO in S306), the character search unit 24 decides that the designated keyword is included in the search target frame, and the character search unit 24 stores the reproducing position of the search target frame to end the character string sensing processing to the search target frame (S307).

On the other hand, when the unprocessed character in which the search is not performed yet exists (YES in S306), the character search unit 24 obtains the character (in the example illustrated in FIG. 10, character “ [symbol] ”) having the topmost search sequence in the unprocessed characters (for example, as illustrated in FIG. 10, the characters to which the already-sensed flag is not provided) as the next sensing target character (S308).

The character search unit 24 restricts the search target region based on the position of the already-sensed character “ [symbol] ” (S309). For example, in the search target frame illustrated in FIG. 12, the search target region may be restricted to the neighboring regions (1) to (4) of the character “ [symbol] ”. Alternatively, according to the character sequence illustrated in FIG. 10, because the already-sensed character “ [symbol] ” is the second character while the sensing target character “ [symbol] ” is the third character, the search target regions may be restricted to the right region (1) and lower region (2) of the character “ [symbol] ”.

The character search unit 24 performs the matching of the feature quantity of the sensing target character “ [symbol] ” to the restricted search target region to search the character (S310).

When the target character exists in the search target region (YES in S311), the already-sensed flag is set to the character sensed in S305. When the unprocessed character exists, the character string searching processing is repeated (S308 to S310). When the unprocessed character does not exist, the character string sensing processing is ended in the search target frame (S307).

On the other hand, when the target character does not exist in the search target region (NO in S311), the region is expanded to the whole region of the frame to search the sensing target character (S312). When the target character does not exist (NO in S303), the character string sensing processing is ended in the search target frame (S304).

When the character search unit 24 ends the character string sensing processing in the search target frame (S304 or S307), the moving image reproducing unit 25 advances the reproduction of the moving image until the reproducing position reaches the next search target frame, and the character string search processing is performed to the new search target frame.

According to the configuration of the character string sensing device 3 and the character string sensing method, the character string sensing device 3 can search the characters in the order from the hardly-falsely-sensed character when sensing the designated keyword from the processing target image. The hardly-falsely-sensed character has the high possibility of being correctly and early sensed from fewer candidates than the easily-falsely-sensed characters. Accordingly, when compared with the case where the characters are sequentially searched according to the character alignment of the keyword, the target character string can be sensed more accurately and more efficiently from the image in a short time through the low-load processing.

According to the character string sensing device 3, because the character matching is performed one by one using the feature quantity of each character, it is not necessary to retain the character string images or feature quantities of the plural characters as a sample. That is, it is not necessary to prepare both samples of the horizontal writing and vertical writing, which allows the memory saving to be realized in the character information storage unit 32. The processing time can advantageously be shortened than ever before.

The character string sensing device 3 of one or more embodiments has the configuration in which the character matching is performed one by one using the feature quantity of each character even if the keyword including the plural characters is sensed from the image. One of the features of the character string sensing device 3 is that the character string search processing is performed in the order from the hardly-falsely-sensed character irrespective of the character alignment of the keyword.

As described above, in the configuration in which the characters are searched one by one from the target image, it is not necessary to produce both the plural character string images of the horizontal writing and vertical writing. Therefore, the configuration has the advantage in both the processing time and memory capacity over the conventional technology. However, the following issues are generated in the configuration. The issues will be described below by taking a specific example.

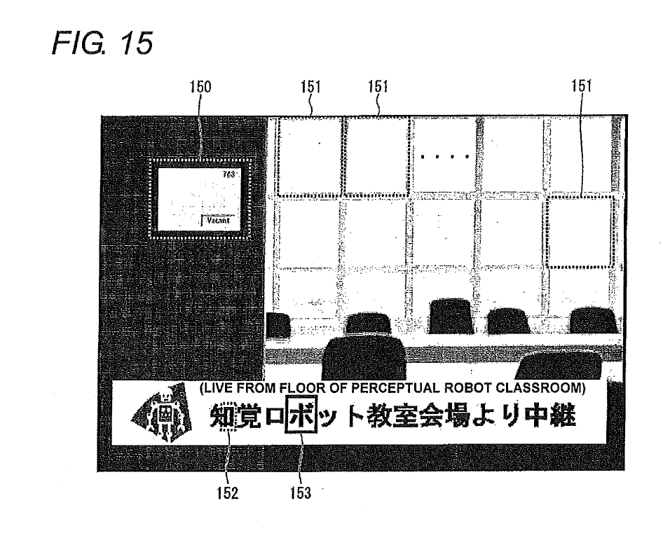

Generally many simple patterns, such as “ [symbol] ”, “ [symbol] ”, and “ [symbol] ”, which areformed by vertical and horizontal edges, exist occasionally in the background image (non-character image). For example, it is assumed that the character string “ [symbol] ” is designated as the keyword to be searched while the image illustrated in FIG. 15 is set to the search target image. When the characters are search in the order from the first character “ [symbol] ”, because many regions of the shapes similar to the character “ [symbol] ” exist, undesired candidates are lined up in the stage at which the first character is searched. When “ [symbol] ” is searched from the image illustrated in FIG. 15, a picture frame 150, a window frame 151, and a right-hand-side portion 152 of the kanji character “ [symbol] ” are falsely sensed while incorrectly perceived as the character “ [symbol] ”. The undesired candidates are lined up by the false sensing, which results in extra processing time being wasted. When a restriction is provided to the number of candidates, although the katakana “ [symbol] ” in a caption should be lined up as the head candidate, a correct candidate 153 is out of from the candidate because of so many false candidate, which results in sensing accuracy being degraded.

The character, such as the character “ [symbol] ”, which has the high probability of constituting the element (such as “left-hand side” of kanji character and “right-hand side” of kanji character) of another character, has a higher probability that the element of another character is falsely lined up as the candidate in addition to the target character to be sensed. For example, when the character string “ [symbol] ” is designated as the keyword, the character “ [symbol] ” is the “left-hand side” of kanji character “ [symbol] ” and the “right-hand side” of kanji character “ [symbol] ”, and the character “ [symbol] ” has the high probability of becoming the element of another character. Therefore, for example, when the characters are searched in the order from the character “ [symbol] ” while the character string “ [symbol] [symbol] ” exists in the target image, not only the character “ [symbol] ” but also the “right-hand side” of kanji character “ [symbol] ” are lined up as the candidate at the initial search stage, whereby the extra processing time is required. When the restriction is provided to the number of candidates, occasionally the correct character string is out of from the candidate, thereby degrading the sensing accuracy.

When the characters are compared to each other using the feature quantity of the character shape, there are notations such as “desk” and “DESK”, “ [symbol] ” and “ [symbol] ”, and “ [symbol] ” and “ [symbol] ”, which have the same meaning and the different shapes. When the notations having the same meaning and the different shapes are considered, unfortunately the processing time is lengthened.

However, the character evaluating device 2 of one or more embodiments evaluates the character from the viewpoint of the difficulty of false sensing to provide the evaluation value, and the character evaluating device 2 can objectively decide how much the character is hardly falsely sensed (or easily falsely sensed). The character string sensing device 3 of one or more embodiments is configured to search the characters in the order from the hardly-falsely-sensed character when the characters of the keyword are searched one by one.

Therefore, the extremely low evaluation is given to the character such as the character “ [symbol] ” which is easily falsely sensed, and the easily-falsely-sensed character receives a low priority. On the other hand, the character such as the character “ [symbol] ” which is relatively hardly falsely sensed and easily correctly sensed is preferentially searched. The low evaluation is also given to the character that has the different notation, in which the long processing time is required, and the character receives a low priority.

Thus, in one or more embodiments of the invention, when the designated character string is searched from the target image, the characters are searched in the descending order of the evaluation value, which allows the shortening of the processing time. The characters are also searched in the order from the easily-correctly-sensed character, which allows the accuracy improvement effect to be expected. Because the character matching is performed one by one, the feature quantity of the model is retained one by one, which allows the memory saving effect to be expected.

Many character images have the following features. That is, compared with the image except the character, edges (lines) exist densely, and the edge has the high different orientation property (lines are oriented toward various directions). Accordingly, the character having the particularly strong features tends to be easily sensed and hardly falsely sensed (having the low probability of falsely sensing the background pattern as the character). Therefore, the candidate can effectively be narrowed at the initial search stage by starting the search from the character having the large evaluation value in which the feature is defined as an index, so that the processing time can be shortened.

For example, when the character string “ [symbol] ” is designated as the keyword, the search is not started from the character “ [symbol] ” which is likely to be similar to the pattern in background image (see FIG. 15), but the search is started from the character “ [symbol] ” in which the edges exist densely and the edge has the high different orientation property. Therefore, undesired candidates are unlikely to be lined up at the initial search stage. As a result, the processing time can be shortened. Even if the restriction is provided to the number of candidates, it is unlikely that the correct character string is excluded from the candidate, and therefore the sensing accuracy can be improved.

In the character having the high probability of becoming the element (such as “left-hand side” of kanji character and “right-hand side” of kanji character) of another character, probably the element of another character is falsely lined up as the candidates in addition to the target character to be sensed. For example, when the character string “ [symbol] ” is designated as the keyword, the character “ [symbol] ” is the “left-hand side” of kanji character “ [symbol] ” and the “right-hand side” of kanji character “ [symbol] ”, and the character “ [symbol] ” has the high probability of becoming the element of another character. Therefore, for example, when the characters are searched in the order from the character “ [symbol] ” while the character string “ [symbol] ” exists in the target image, not only the character “ [symbol] ” but also the “right-hand side” of kanji character “ [symbol] ” are lined up as the candidate at the initial search stage. On the other hand, when the search is started from the character “ [symbol] ” having the low probability of becoming the element of another character, probably only the character “ [symbol] ” is lined up as the candidate from the character string “ [symbol] ” at the initial search stage. Therefore, the candidate can effectively be narrowed at the initial search stage by starting the search from the character having the large evaluation value that is defined by focusing on this point, so that the processing time can be shortened.

Even if the restriction is provided to the number of candidates, it is unlikely that the correct character string is excluded from the candidate, and therefore the sensing accuracy can be improved.

The character having no different notation or the character having different notations which are similar shape to each other only requires searching one type of character shape when the target image is searched. Therefore, the sensing is easily and quickly performed compared with the character in which at least two types of character shapes are searched. Accordingly, the processing time can be shortened by starting the search from the character having the large evaluation value that is defined by focusing on this point.

According to the character string sensing method of one or more embodiments, because the characters are searched one by one, it is not necessary to produce the character string images of both the horizontal writing and vertical writing. Therefore, the memory saving can be established.

In the character string sensing device 3 of one or more embodiments, after the characters are searched in the order from the hardly-falsely-sensed character to sense the target character, the search target region is not set to the whole image in performing the character sensing processing to the characters subsequent to the first character, but the search target region can be narrowed to the neighboring region of the already-sensed character.

According to the configuration, when the character search unit 24 searches the character “ [symbol] ”, the characters “ [symbol] ”, “ [symbol] ”, and “ [symbol] ” having the evaluation value higher than that of the character “ [symbol] ” have already been sensed, and the region where probably the character “ [symbol] ” exists can be restricted from the positional relationship of the characters “ [symbol] ”, “ [symbol] ”, and “ [symbol] ”. In the example illustrated in FIG. 12, the region where probably the character “ [symbol] ” exists can be restricted to the region (3).

In the configuration in which the character “ [symbol] ” is searched from the whole image, the false candidates such as the picture frame 150 and the window frame 151 are lined up. On the other hand, in the configuration of one or more embodiments in which the character “ [symbol] ” is searched from the restricted region (3), even if the false sensing is generated, only the portion 152 of the right-hand side of the kanji character “ [symbol] ” is lined up as the candidate.

Thus, the processing load can be largely reduced, and therefore the processing time is largely shortened to efficiently and accurate sensing of the keyword from the image can be performed.

The invention is not limited to one embodiment, but various changes can be made without departing from the scope of the invention. An embodiment obtained by appropriately combining technical means also included in the technical range of the invention.

Finally, each block of the character evaluating device 2 and character string sensing device 3, particularly the character analysis unit 20, the evaluation value computing unit 21, the keyword obtaining unit 22, the search sequence determining unit 23, and the character search unit 24 may be formed by hardware logic or may be realized as follows by software using the CPU.

That is, the character evaluating device 2 (character string sensing device 3) includes the CPU (Central Processing Unit) that executes a command of a control program realizing each function, the ROM (Read Only Memory) in which the program is stored, the RAM (Random Access Memory) in which the program is expanded, and the storage device (recording medium) such as a memory in which the program and various pieces of data are stored. Implementation and balance may be achieved by supplying the recording medium, in which program codes (an executable format program, an intermediate code program, and a source program) of the control programs that are of the software realizing the functions in the character evaluating device 2 (character string sensing device 3) are recorded so that the computer can read the program codes, to the character evaluating device 2 (character string sensing device 3), and the computer (or the CPU or MPU) reads and executes the program code recorded in the recording medium.

Examples of the recording medium include tape system such as magnetic tape and cassette tape, disk systems including magnetic disks such as floppy disk (registered trademark) and a hard disk and optical disks such as a CD-ROM, an MO an MD, a DVD, and a CD-R, card systems such as an IC card (including a memory card) and an optical card, and semiconductor memory systems such as a mask ROM, an EPROM, an EEPROM and a flash ROM.

The character evaluating device 2 (character string sensing device 3) may be configured to be able to be connected to a communication network so that the program code is supplied through the communication network. There is no particular limitation to the communication network. Examples of the communication network include the Internet, an intranet, an extranet, a LAN, an ISDN, a VAN, a CATV communication network, a virtual private network, a telephone line network, a mobile communication network, and a satellite communication network. There is no particular limitation to a transmission medium included in the communication network. Examples of the transmission medium include wired lines such as IEEE 1394, a USB, a power-line carrier, a cable TV line, a telephone line, and an ADSL line and wireless lines such as infrared ray such as IrDA and a remote controller, Bluetooth (registered trademark), 802.11 wireless, HDR, a mobile telephone network, a satellite line, and a terrestrial digital network. One or more embodiments of the invention can be realized in the form of a computer data signal embedded in a carrier wave in which the program code is embodied by electronic transmission.

The character string sensing device of one or more embodiments of the invention can sense the designated character from the image in a short time through the low-load processing, so that the character string sensing device can be applied to various image processing devices, such as a digital video recorder/player, a Blu-ray disk player, a digital video camera, a digital camera, a digital television set, a personal computer, a mobile phone, a printer, and a scanner, which process the still image and/or the moving image. Because the character string sensing device of one or more embodiments of the invention can sense the character string in a short time on a real-time basis even in the large-load moving image processing, particularly the character string sensing processing is advantageously applied to the moving image processing device or moving image reproducing device.

While the invention has been described with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

1. A character string sensing device that senses a character string comprising at least one character from an image, wherein the character string sensing device comprises:
a character information storage unit in which an evaluation value, expressing difficulty of false sensing of the character, is stored by each character;
a search sequence determining device for determining a search sequence of each character to search the character from the image based on the evaluation value of each character included in a sensing target character string input to the character string sensing device, wherein the evaluation value is stored in the character information storage unit; and
a character search device for searching the image in each character included in the sensing target character string according to the search sequence.

2. The character string sensing device according to claim 1, wherein the search sequence determining device determines that a character, having the largest evaluation value expressing the difficulty of false sensing, is initially searched in the characters included in the sensing target character string.

3. The character string sensing device according to claim 1, wherein the search sequence determining device determines the character having the larger evaluation value as a next searched character in the characters on both sides of an already-sensed character in a character alignment of the sensing target character string, when the character search device senses a target character included in the sensing target character string from the image.

4. The character string sensing device according to claim 1, wherein the search sequence determining device determines the search sequence such that the characters are searched in the descending order of the evaluation value.

5. The character string sensing device according to claim 1, wherein the character search device narrows a search target region where the next character is searched to a neighboring region of the already-sensed character from a whole region of the image after sensing the target character included in the sensing target character string from the image.

6. The character string sensing device according to claim 5,
wherein the character search device restricts the search target region to neighboring regions on the right side of and below the already-sensed character, when the already-sensed character is an nth character in the character alignment of the sensing target character string while the next searched character is a character subsequent to an nth character, and
wherein the character search device restricts the search target region to neighboring regions on the left side of and above the already-sensed character, when the next searched character is a preceding character of the nth character.

7. The character string sensing device according to claim 1,
wherein the evaluation value is computed based on a shape characteristic of the character, in which a character having a more complicated shape is evaluated as having a higher difficulty of false sensing, and
wherein the evaluation value is computed based on at least one of a characteristic value of an element length expressing a length of a line constituting the character and a characteristic value of a different orientation property expressing versatility of an orientation of the line constituting the character.

8. The character string sensing device according to claim 1,
wherein the evaluation value is computed based on the characteristic value of ease of discrimination expressing a degree in which the character is easily discriminated from another character, and
wherein a character having a shape less similar to another character or a part of another character is evaluated as having a higher difficulty of false sensing.

9. The character string sensing device according to claim 1,
wherein the evaluation value is computed based on a characteristic value of notation uniformity which is specified based on presence or absence of different notation or a degree of similarity between different notation characters when the different notation is present, and
wherein a character having more uniform notation is evaluated as having a higher difficulty of false sensing.

10. The character string sensing device according to claim 7, wherein the characteristic value of the element length and the characteristic value of the different orientation property are computed by adding a weight to an obliquely-oriented line constituting the character rather than a vertically- or horizontally-oriented line constituting the character.

11. The character string sensing device according to claim 1,
wherein the image is a moving image including a plurality of frames,
wherein the character search device searches each character included in the sensing target character string in each search target frame that is extracted as a search target from the moving image, and
wherein the character search device ends the search in the search target frame when the character search device does not detect a target character from the search target frame in searching each character according to the search sequence, and searches the character having the first search sequence in the next search target frame.

12. A character evaluating device comprising:
a character analysis device for analyzing a character characteristic of an evaluation target character input as a character whose difficulty of false sensing is evaluated;
a character characteristic storage unit in which the character characteristic of each character is previously stored;
a characteristic value specifying device for specifying a characteristic value of each character characteristic of the evaluation target character based on at least one of the character characteristic analyzed by the character analysis device and the character characteristic stored in the character characteristic storage unit;
an evaluation value computing device for computing an evaluation value expressing difficulty of false sensing of the character using at least one characteristic value specified by the characteristic value specifying device; and
an evaluation value storage device for storing the evaluation value computed by the evaluation value computing device in a character information storage unit while correlating the evaluation value with the evaluation target character.

13. The character evaluating device according to claim 12,
wherein the character analysis device analyzes a shape characteristic of the evaluation target character, and
wherein the characteristic value specifying device computes at least one of a characteristic value of an element length expressing a length of a line constituting the character and a characteristic value of a different orientation property expressing versatility of an orientation of the line constituting the character with respect to the evaluation target character based on analysis result of the character analysis device.

14. The character evaluating device according to claim 12,
wherein the character characteristic storage unit stores the characteristic value of ease of discrimination expressing a degree in which the character is easily discriminated from another character as a character characteristic by each character,
wherein a character having a shape less similar to another character or a part of another character is evaluated as having a higher difficulty of false sensing, and
wherein the characteristic value specifying device specifies the characteristic value of the ease of discrimination of the evaluation target character based on the character characteristic of the evaluation target character stored in the character characteristic storage unit.

15. The character evaluating device according to claim 12,
wherein the character characteristic storage unit correlates a group of different notation characters and a degree of similarity between different notation characters and stores them as a character characteristic,
wherein the characteristic value specifying device specifies a characteristic value of notation uniformity of the evaluation target character based on presence or absence of different notation of the evaluation target character or a degree of similarity between different notation characters when the different notation is present, and
wherein a character having more uniform notation is evaluated as having a higher difficulty of false sensing.

16. An image processing device comprising the character string sensing device according to claim 1.

17. A character string sensing method for sensing a character string including at least one character from an image, the character string sensing method comprising:
obtaining a sensing target character string that is input as the character string to be sensed;
determining a search sequence of each character for searching the character from the image based on an evaluation value of each character included in the sensing target character string obtained in the character string obtaining step, wherein the evaluation value of each character is being stored in a character information storage unit, and wherein the evaluation value expresses difficulty of false sensing of the character; and
searching the image by each character included in the sensing target character string according to the search sequence determined in the search sequence determining step.

18. A character evaluating method comprising the steps of:
analyzing character characteristic of an evaluation target character that is input as a character whose difficulty of false sensing should be evaluated;
specifying a characteristic value of each character characteristic of the evaluation target character based on at least one of the character characteristic analyzed in the character analyzing step and a character characteristic stored in a character characteristic storage unit, wherein the character characteristic of each character is being previously stored in the character characteristic storage unit;
computing evaluation value expressing difficulty of false sensing of the character using at least one characteristic value specified in the characteristic value specifying step; and
storing the evaluation value computed in the evaluation value computing step in a character information storage unit while the evaluation value is correlated with the evaluation target character.

19. A non-transitory computer-readable recording medium storing a control program that causes a computer to execute the method of to claim 17.

20. A computer-readable recording medium storing a control program that causes a computer to execute the method of claim 18.
